(19) United States
(12) Patent Application Publication
(10) Pub. No.: US 2024/0265629 A1
(43) Pub. Date: Aug. 8, 2024

(54) POINT CLOUD DATA PROCESSING APPARATUS, POINT CLOUD DATA PROCESSING METHOD AND PROGRAM

(71) Applicant: NIPPON TELEGRAPH AND TELEPHONE CORPORATION, Tokyo (JP)

(72) Inventors: Mayuko WATANABE, Musashino-shi, Tokyo (JP); Ryuichi TANIDA, Musashino-shi, Tokyo (JP); Isamu IGARASHI, Musashino-shi, Tokyo (JP); Hideaki KIMATA, Musashino-shi, Tokyo (JP)

(73) Assignee: NIPPON TELEGRAPH AND TELEPHONE CORPORATION, Tokyo (JP)

(21) Appl. No.: 18/291,572

(22) PCT Filed: Aug. 6, 2021
(86) PCT No.: PCT/JP2021/029321

§ 371 Date: Jan. 23, 2024

(51) Int. Cl. G06T 17/00; G06T 7/11; G06T 9/00; G06T 9/40

(52) U.S. Cl. CPC G06T 17/00; G06T 7/11; G06T 9/001; G06T 9/40

(57) ABSTRACT

A point cloud data processing device includes: a point cloud data storage unit that stores a plurality of pieces of point cloud data measured at an arbitrary measurement time at a plurality of measurement positions in a three-dimensional space; and a merged point cloud data generation unit that generates merged point cloud data in a time-series order based on the point cloud data stored in the point cloud data storage unit, the merged point cloud data including the point cloud data corresponding to any one of the measurement times, location data indicating a location of a point when pieces of point cloud data measured before the measurement time were integrated in a time-series order, and reference data assigned to each piece of location data, for specifying the point cloud data including the point indicated by the location data

### TECHNICAL FIELD

The present invention relates to a point cloud data processing device, a point cloud data processing method, and a program.

### BACKGROUND ART

In recent years, point cloud data has been used in various fields, and in order to handle point cloud data according to a common standard, for example, a standard called G-pcc (Geometry based Point Cloud Compression) is currently being studied. In G-pcc, the occupancy state of the points included in the point cloud data is expressed by the structure of an Octree (hereafter referred to as an octree) in units of 2ⁿ×2ⁿ×2ⁿ voxels, and the expressed octree structure is encoded (for example, see Non-Patent Literature 1). Thus, various processes can be easily performed on the points included in the point cloud data under a common standard.

Incidentally, as for point cloud data, there is a demand to integrate a plurality of pieces of point cloud data obtained by measuring at different positions at different times. For example, there may be a demand to acquire point cloud data in the direction of a building from four locations of the building, and integrate the acquired four pieces of point cloud data to generate point cloud data of the building and surrounding structures. There is also a demand to update to the latest point cloud data by merging the already acquired point cloud data and newly acquired point cloud data. There is also a demand to generate point cloud data at an arbitrary time and point cloud data at an arbitrary measurement position from already acquired point cloud data, and use the generated point cloud data to observe temporal changes in buildings and streets.

### CITATION LIST

### Non-Patent Literature

Non-Patent Literature 1: “Information technology—MPEG I (Coded Representation of Immersive Media)—Part9: Geometry-based Point Cloud Compression)”, ISO/IEC 23090-9, ISO/IEC JTC 1/SC 29/WG 11,2019.

### SUMMARY OF INVENTION

### Technical Problem

The G-pcc described above does not take into account where and when the point cloud data was acquired, as with image coding standards such as high efficiency video coding (HEVC). Therefore, there is a problem that the above-mentioned demands cannot be satisfied.

Point cloud data of all the times are not acquired at all the measurement positions. Therefore, when observing temporal changes as described above, a plurality of pieces of point cloud data before each of a plurality of times are integrated to generate the point cloud data of each time from a plurality of pieces of point cloud data existing in a large amount. In this case, each time, it is necessary to read a plurality of pieces of point cloud data and arrange them in the time-series order with reference to the measured time, and there is a problem that this processing takes a long time.

In view of the above circumstances, an object of the present invention is to provide a technique through which the time required for integrating a plurality of pieces of point cloud data acquired at an arbitrary time and arbitrary measurement positions can be shortened.

### Solution to Problem

One aspect of the present invention provides a point cloud data processing device including: a point cloud data storage unit that stores a plurality of pieces of point cloud data measured at an arbitrary measurement time at a plurality of measurement positions in a three-dimensional space; and a merged point cloud data generation unit that generates merged point cloud data in a time-series order based on the point cloud data stored in the point cloud data storage unit, the merged point cloud data including the point cloud data corresponding to any one of the measurement times, location data indicating a location of a point when pieces of point cloud data measured before the measurement time were integrated in a time-series order, and reference data assigned to each piece of location data, for specifying the point cloud data including the point indicated by the location data.

One aspect of the present invention provides a point cloud data processing method including: allowing a point cloud data storage unit to store a plurality of pieces of point cloud data measured at an arbitrary measurement time at a plurality of measurement positions in a three-dimensional space; and allowing a merged point cloud data generation unit to generate merged point cloud data in a time-series order based on the point cloud data stored in the point cloud data storage unit, the merged point cloud data including the point cloud data corresponding to any one of the measurement times, location data indicating a location of a point when pieces of point cloud data measured before the measurement time were integrated in a time-series order, and reference data assigned to each piece of location data, for specifying the point cloud data including the point indicated by the location data.

One aspect of the present invention provides a program for causing a computer to function as: a point cloud data storage means that stores a plurality of pieces of point cloud data measured at an arbitrary measurement time at a plurality of measurement positions in a three-dimensional space; and a merged point cloud data generation means that generates merged point cloud data in a time-series order based on the point cloud data stored in the point cloud data storage means, the merged point cloud data including the point cloud data corresponding to any one of the measurement times, location data indicating a location of a point when pieces of point cloud data measured before the measurement time were integrated in a time-series order, and reference data assigned to each piece of location data, for specifying the point cloud data including the point indicated by the location data.

### Advantageous Effects of Invention

According to this invention, it is possible to shorten the time required for integrating a plurality of pieces of point cloud data acquired at an arbitrary time and arbitrary measurement positions.

### BRIEF DESCRIPTION OF DRAWINGS

FIG. 1 is a block diagram showing the configuration of a point cloud data processing device according to a first embodiment.

FIG. 2 is a diagram showing an example of file names and data formats of point cloud data stored in a point cloud data storage unit according to the first embodiment.

FIG. 3 is a diagram showing an example of a data format of merged point cloud data in the first embodiment.

FIG. 4 is a diagram showing an example of a data format of reference list data in the first embodiment.

FIG. 5 is a diagram showing the flow of processing of generating merged point cloud data and reference list data according to the first embodiment.

FIG. 6 is a diagram (part 1) showing an example of processing of generating merged point cloud data and reference list data according to the first embodiment.

FIG. 7 is a diagram (part 2) showing an example of processing of generating merged point cloud data and reference list data according to the first embodiment.

FIG. 8 is a diagram for explaining repeated processing in the processing of generating merged point cloud data and reference list data according to the first embodiment.

FIG. 9 is a diagram showing the flow of point cloud data generation processing according to the first embodiment.

FIG. 10 is a diagram showing an example of point cloud data generation processing according to the first embodiment.

FIG. 11 is a block diagram showing the configuration of a point cloud data processing device according to a second embodiment.

FIG. 12 is a diagram for explaining octree encoding performed by an encoding processing unit of the second embodiment.

FIG. 13 is a diagram showing an example of a data format of encoded point cloud data in the second embodiment.

FIG. 14 is a diagram showing an example of file names of point cloud data stored in a point cloud data storage unit according to the second embodiment.

FIG. 15 is a diagram showing an example of processing of generating merged point cloud data and reference list data in the second embodiment.

FIG. 16 is a diagram (part 1) showing the flow of point cloud data generation processing according to the second embodiment.

FIG. 17 is a diagram (part 2) showing the flow of point cloud data generation processing according to the second embodiment.

FIG. 18 is a diagram showing the flow of a subroutine for tile merging processing performed in point cloud data generation processing according to the second embodiment.

FIG. 19 is a diagram (part 1) showing an example of point cloud data generation processing in the second embodiment.

FIG. 20 is a diagram (part 2) showing an example of point cloud data generation processing in the second embodiment.

### DESCRIPTION OF EMBODIMENTS

### First Embodiment

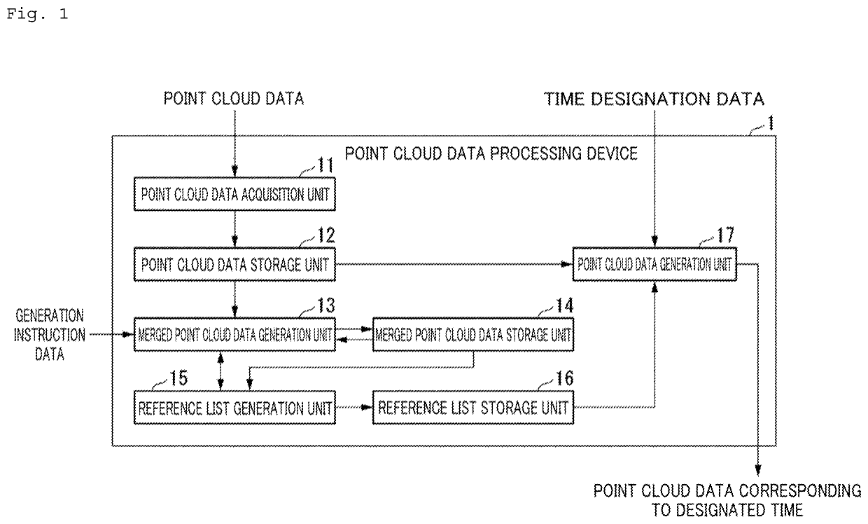

Hereinafter, an embodiment of the present invention will be described with reference to the drawings. FIG. 1 is a block diagram showing the configuration of a point cloud data processing device 1 according to the first embodiment. The point cloud data processing device 1 includes a point cloud data acquisition unit 11, a point cloud data storage unit 12, a merged point cloud data generation unit 13, a merged point cloud data storage unit 14, a reference list generation unit 15, a reference list storage unit 16, and a point cloud data generation unit 17.

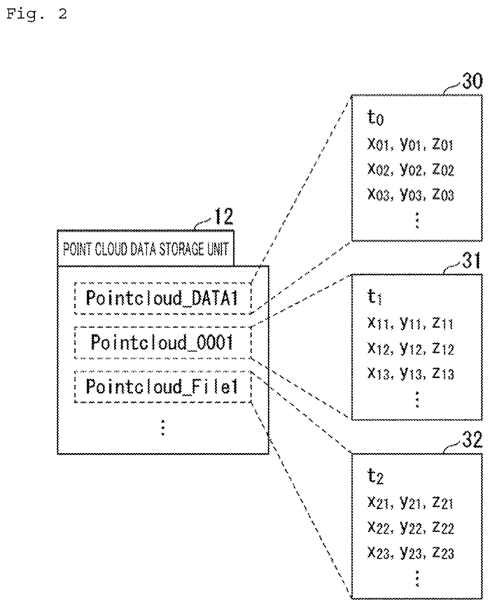

The point cloud data acquisition unit 11 is connected to, for example, a measuring device such as a three-dimensional laser scanner that generates point cloud data, receives an operation of the user of the point cloud data processing device 1, and acquires point cloud data designated by the user from the measuring device. The point cloud data storage unit 12 stores the point cloud data acquired by the point cloud data acquisition unit 11. As shown in FIG. 2, the point cloud data storage unit 12 stores a plurality of pieces of point cloud data in the form of files. As an example, FIG. 2 shows an example in which the point cloud data storage unit 12 stores point cloud data files whose file names are “Pointcloud_DATA1”, “Pointcloud_0001”, and “Pointcloud_File1”.

The frame of reference sign 30 indicates data included in the file “Pointcloud_DATA1”, the frame of reference sign 31 indicates the data included in the file of “Pointcloud_0001”, and the frame of reference sign 32 indicates the data included in the file “Pointcloud_File1”. As indicated by the frames of reference signs 30, 31, and 32, the point cloud data includes measurement time data indicating the time when the measurement was performed and coordinate data indicating the positions of a plurality of points included in the point cloud data by the coordinate values of the X-axis, Y-axis, and Z-axis of a three-dimensional coordinate system. In the example shown in FIG. 2, for example, “t₀” in the frame of reference sign 30, “t₁” in the frame of reference sign 31, and “t₂” in the frame of reference sign 32 are measurement time data. “x₀₁, y₀₁, z₀₁”, “x₀₂, y₀₂, z₀₂”, in the frame of reference sign 30, “x₁₁, y₁₁, z₁₁”, “x₁₂, y₁₂, z₁₂”, in the frame of reference sign 31, “x₂₁, y₂₁, z₂₁”, and “x₂₂, y₂₂, z₂₂”, in the frame of reference sign 32 are coordinate data.

The measurement time data is data indicating the time represented by a year, month, day, hour, minute, and second. Hereinafter, the term “time” indicates the time represented by a year, month, day, hour, minute, and second. The coordinate values of the X-axis, Y-axis, and Z-axis indicating the positions of points included in each of the plurality of pieces of point cloud data are coordinate values in the same three-dimensional coordinate system.

The time indicated by the measurement time data included in the point cloud data indicates, for example, the time when a point cloud data file was generated in the measuring device, rather than strictly indicating the time when each point included in the point cloud data was measured because the point cloud data includes a plurality of points. The respective pieces of point cloud data may be the point cloud data generated by different measuring devices. Therefore, there may be pieces of point cloud data having the same measurement time. In many cases, the size of the range in which the points included in the point cloud data exist in a three-dimensional space (the range will be referred to as the range of point cloud data) may be the same although the size may be different in respective pieces of point cloud data. The positions of the ranges of point cloud data may be the same or different. In the case where the ranges are at different positions, a part of the range of point cloud data may overlap with another range of point cloud data. For example, when measuring temporal changes in the shape of the same building, the measurement is performed so that the ranges measured by a measuring device installed at a fixed position have the same size. In this case, a plurality of pieces of point cloud data obtained from the measuring device is a plurality of pieces of point cloud data with different measurement times, in which the ranges of the respective pieces of point cloud data are at the same position and have the same size.

As the file format of the point cloud data file, for example, a “.ply” format or a “.csv” format can be applied, and one of the file formats is determined in advance as the file format to be processed by the point cloud data processing device 1. A plurality of pieces of point cloud data files are given different file names. As an example, FIG. 2 shows an example in which character strings “DATA1”, “0001”, and “File1” are added to a common character string “Pointcloud_”.

As shown in FIG. 2, the point cloud data stored in the point cloud data storage unit 12 has various file names. Thus, when the pieces of point cloud data are arranged in the order of measurement time, it is necessary to read a plurality of pieces of point cloud data and refer to the measurement time indicated by the measurement time data included in each of the pieces of point cloud data. Upon acquiring a generation instruction data including information indicating merge all, the merged point cloud data generation unit 13 refers to the measurement time data included in all pieces of point cloud data stored in the point cloud data storage unit 12 to arrange the point cloud data in the time-series order. Here, the time-series order is a time-series order starting with the point cloud data generated at the earliest time, that is, the oldest point cloud data. Hereinafter, when referring to a time-series order, it indicates the same order. The merged point cloud data generation unit 13 repeats integration, that is, merging, of pieces of point cloud data one by one in the time-series order with respect to the leading point cloud data in the time-series order to generate merged point cloud data whenever one piece of point cloud data is merged. Upon acquiring generation instruction data including information indicating individual merges associated with the file name of one piece of point cloud data, the merged point cloud data generation unit 13 merges point cloud data of a file name associated with the information indicating individual merges included in the generation instruction data with merged point cloud data that has already been generated to generate new merged point cloud data.

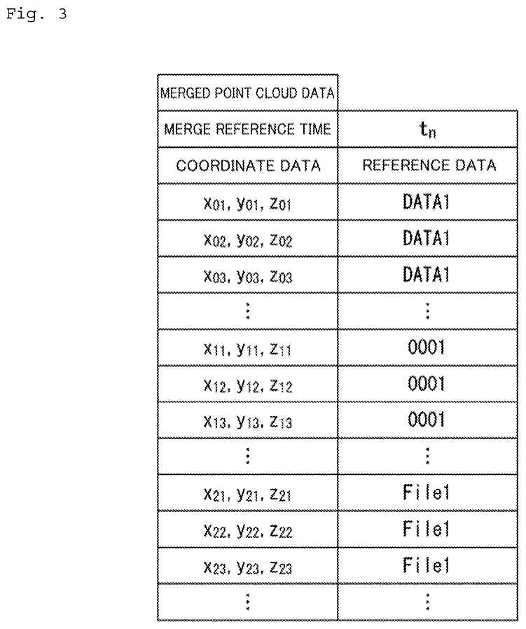

The merged point cloud data storage unit 14 stores the merged point cloud data generated by the merged point cloud data generation unit 13. The data format of the merged point cloud data is, for example, the data format shown in FIG. 3, and has items of “merge reference time”, “coordinate data”, and “reference data”. The time indicated by the measurement time data included in the point cloud data merged last is written in the “merge reference time” item. The coordinate data of the merged point cloud data is written in the “coordinate data” item. Reference data, which is data capable of specifying which point cloud data file includes each piece of merged coordinate data is written in the “reference data” item. FIG. 3 shows an example in which the character strings “DATA1”, “0001”, and “File1”, which are the remaining character strings excluding the common character string “Pointcloud_” in the file names of the point cloud data, are written as reference data. The reference data may be any data as long as it can specify which point cloud data file the coordinate data is included in. For example, the reference data may be the entire file names of the point cloud data.

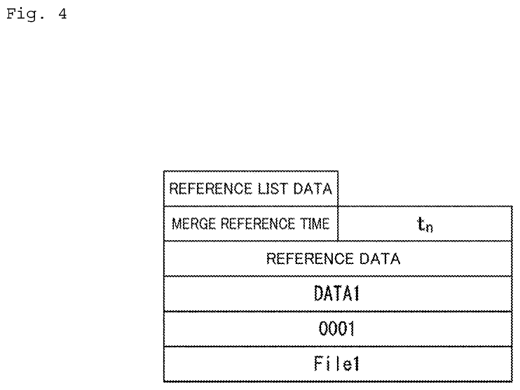

The reference list generation unit 15 generates reference list data from the merged point cloud data stored in the merged point cloud data storage unit 14. The data format of the reference list data is, for example, the data format shown in FIG. 4, and has items of “merge reference time” and “reference data”. The time written in the “merge reference time” item of the merged point cloud data referred to when the reference list generation unit 15 generates the reference list data is written in the “merge reference time” item. Different pieces of reference data among the pieces of reference data written in the “reference data” item of the merged point cloud data referred to when the reference list generation unit 15 generates the reference list data are written in the “reference data” item in the time-series order.

In the case of the merged point cloud data shown in FIG. 3, the reference list generation unit 15 selects different pieces of reference data in the time-series order, for example, as follows. The reference list generation unit 15 selects the reference data “DATA1” in the first row of the “reference data” item of the merged point cloud data as the first reference data, and then moves one row downward, starting from the second row of the “reference data” item of the merged point cloud data to detect reference data different from the reference data selected previously. Upon detecting the different reference data, the reference list generation unit 15 selects the detected reference data as the second reference data. In the example of FIG. 3, the reference list generation unit 15 selects “0001” as the second reference data. After that, the reference list generation unit 15 repeats the same processing until the last row. As a result, the pieces of reference data selected by the reference list generation unit 15 are “DATA1”, “0001”, and “File1”, which are different pieces of reference data arranged in the time-series order.

The reference list storage unit 16 stores the reference list data generated by the reference list generation unit 15. The point cloud data generation unit 17 receives the operation of the user of the point cloud data processing device 1 to acquire time designation data designated by the user. The point cloud data generation unit 17 detects the reference list data corresponding to the time indicated by the acquired time designation data from the reference list storage unit 16. The point cloud data generation unit 17 reads the point cloud data from the point cloud data storage unit 12 in the time-series order based on the reference data written in the “reference data” item of the detected reference list data. The point cloud data generation unit 17 merges the read point cloud data in the time-series order to generate point cloud data corresponding to the time designated by the time designation data.

### (Processing of Generating Merged Point Cloud Data and Reference List Data in First Embodiment)

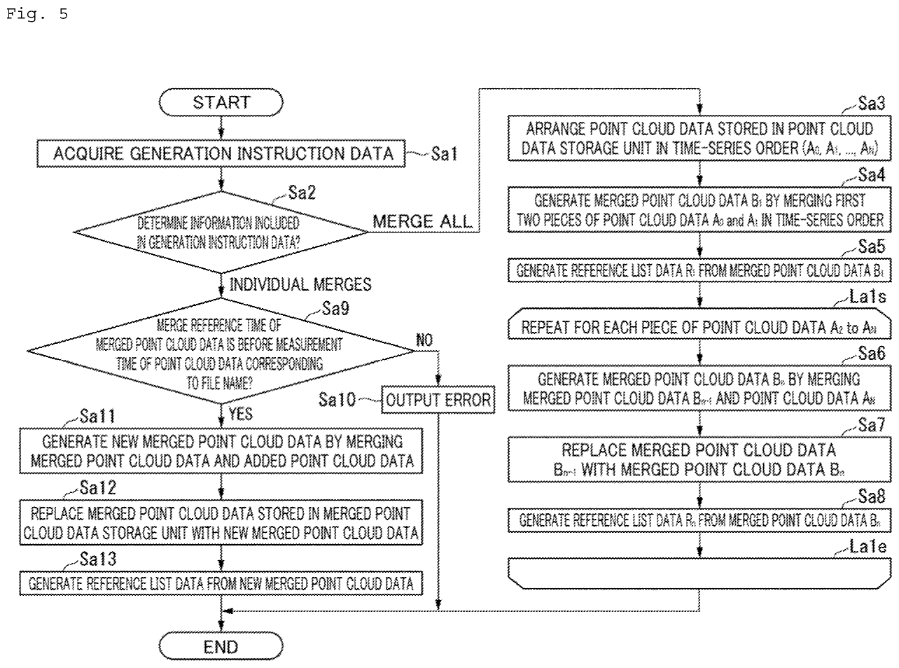

Next, processing of generating merged point cloud data and reference list data by the point cloud data processing device 1 will be described with reference to FIGS. 5 to 8. FIG. 5 is a flowchart showing the flow of processing of generating merged point cloud data and reference list data by the point cloud data processing device 1.

It is assumed that the point cloud data acquisition unit 11 acquires N+1 pieces of point cloud data and writes the acquired point cloud data in the point cloud data storage unit 12 before the processing shown in FIG. 5 is started. Here, N is an integer of 1 or more.

The merged point cloud data generation unit 13 receives the operation of the user of the point cloud data processing device 1 to acquire the generation instruction data designated by the user (step Sa1). Here, it is assumed that the user has provided the merged point cloud data generation unit 13 with generation instruction data including information indicating merge all. The merged point cloud data generation unit 13 determines whether the information included in the acquired generation instruction data is information indicating merge all or information indicating individual merges (step Sa2).

As described above, since the generation instruction data includes information indicating merge all, the merged point cloud data generation unit 13 determines that the information included in the generation instruction data is information indicating merge all (step Sa2, merge all). The merged point cloud data generation unit 13 reads all pieces of point cloud data, that is, N+1 pieces of point cloud data from the point cloud data storage unit 12. The merged point cloud data generation unit 13 arranges the point cloud data in the time-series order by referring to the measurement time data included in the read N+1 pieces of point cloud data (step Sa3). Here, the N+1 pieces of point cloud data arranged in the time-series order by the merged point cloud data generation unit 13 will be denoted as point cloud data A₀, A₁, . . . , A_{N}. In this case, the leading point cloud data A₀ is the point cloud data generated at the earliest time. Note that some of the N+1 pieces of point cloud data may have the same measurement time, and in this case, pieces of point cloud data having the same measurement time are arranged consecutively.

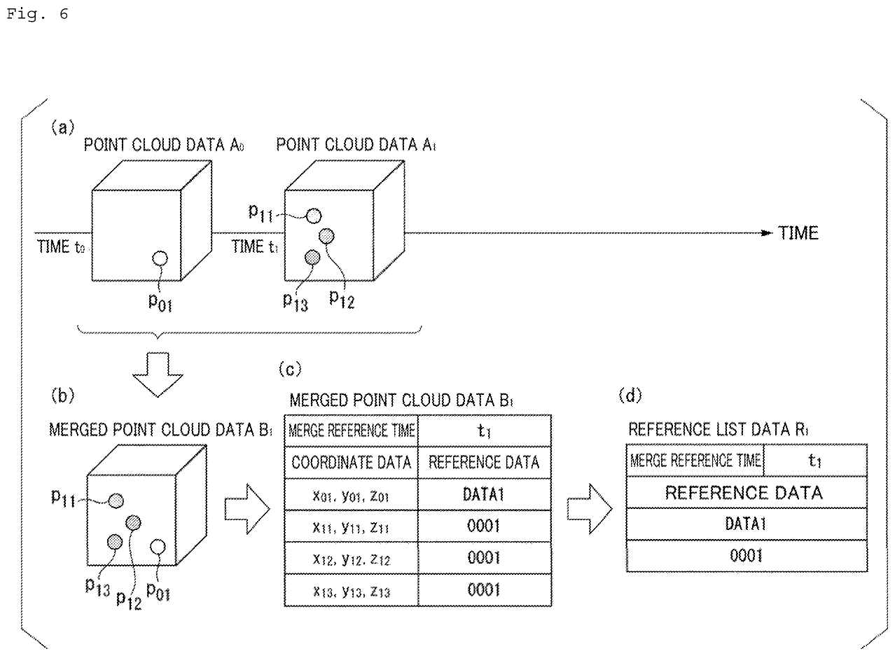

The merged point cloud data generation unit 13 merges the first two pieces of point cloud data A₀ in the time-series order and the point cloud data A₁ to generate merged point cloud data B₁. For example, it is assumed that the point cloud data A₀ and the point cloud data A₁ are such point cloud data as shown in FIG. 6(a). It is assumed that the file name of the point cloud data A₀ is “Pointcloud_DATA1” and the measurement time data is “t₀”. It is assumed that the point cloud data A₀ includes one point p₀₁, and the coordinate data of the point p₀₁ is “x₀₁, y₀₁, z₀₁”. It is assumed that the file name of the point cloud data A₁ is “Pointcloud_0001” and the measurement time data is “t₁”. Here, t₁>to is set, but since the times indicated by the measurement time data included in the point cloud data may be the same time as described above, t₀=t₁ may be established. It is assumed that the point cloud data A₁ includes three points p₁₁, p₁₂, and p₁₃, the coordinate data of the point p₁₁ is “x₁₁, y₁₁, a₁₁”, and the coordinate data of the point p12 is “x₁₂, y₁₂, z₁₂”, and the coordinate data of the point p₁₃ is “x₁₃, y₁₃, z₁₃”.

Here, it is assumed that the point poi does not exist within a range of a predetermined size around each position of the points p₁₁, p₁₂, and p₁₃. In this case, the merged point cloud data B₁ generated by the merged point cloud data generation unit 13 merging the point cloud data A₀ and the point cloud data A₁ includes four points poi, p₁₁, p₁₂, and p₁₃ as shown in FIG. 6(b). Therefore, as shown in FIG. 6(c), the merged point cloud data generation unit 13 writes the time “t” indicated by the measurement time data of the point cloud data A₁ that comes later in the time-series order in the “merge reference time” item and writes the coordinate data of the four points p₀₁, p₁₁, p₁₂, and p₁₃ in the “coordinate data” item in the time-series order. The merged point cloud data generation unit 13 writes “DATA1”, “0001”, “0001” and “0001” which are the reference data for specifying the respective pieces of point cloud data in which the points p₀₁, p₁₁, p₁₂, and p₁₃ were included in the “reference data” item to generate new merged point cloud data B₁.

After generating the merged point cloud data B₁, the merged point cloud data generation unit 13 writes and stores the generated merged point cloud data B₁ in the merged point cloud data storage unit 14. After completing the writing of the merged point cloud data B₁ in the merged point cloud data storage unit 14, the merged point cloud data generation unit 13 outputs a reference list generation start signal to the reference list generation unit 15 (step Sa4).

Upon receiving the reference list generation start signal from the merged point cloud data generation unit 13, the reference list generation unit 15 reads the merged point cloud data B₁ from the merged point cloud data storage unit. The reference list generation unit 15 refers to the read merged point cloud data B₁ to generate reference list data R₁. As shown in FIG. 6(d), the reference list generation unit 15 writes the time “t₁” written in the “merge reference time” item of the merged point cloud data B₁ to be referred to in the “merge reference time” item in the data format of the reference list data. The reference list generation unit 15 writes two pieces of data “DATA1” and “0001” which are the reference data written in the “reference data” item of the merged point cloud data B₁ to be referred to and which are different pieces of reference data in the “reference data” item in the time-series order. In this way, the reference list generation unit 15 generates the reference list data R₁.

After generating the reference list data R₁, the reference list generation unit 15 writes and stores the generated reference list data R₁ in the reference list storage unit 16. After completing the writing of the reference list data R₁ in the reference list storage unit 16, the reference list generation unit 15 outputs a reference list generation end signal to the merged point cloud data generation unit 13 (step Sa5).

When the merged point cloud data generation unit 13 receives the reference list generation end signal from the reference list generation unit 15, the processing of steps Sa6 to Sa8 is repeatedly performed for each of the pieces of point cloud data A₂ to A_{N}. The merged point cloud data generation unit 13 reads merged point cloud data Bₙ₋₁ from the merged point cloud data storage unit 14 with n=2 as an initial value. Here, n is an integer of 2 or more and N or less.

The merged point cloud data generation unit 13 merges the read merged point cloud data Bₙ₋₁ and the point cloud data An to generate new merged point cloud data Bn. For example, when n=2, the merged point cloud data generation unit 13 merges the merged point cloud data B₁ and the point cloud data A₂ to generate merged point cloud data B₂. Here, it is assumed that the file name of the point cloud data A₂ is “Pointcloud File1” and the measurement time data is “t₂”. Note that text. It is assumed that the point cloud data A₂ includes three points p₂₁, p₂₂, and p₂₃, the coordinate data of the point p₂₁ is “x₂₁, y₂₁, z₂₁”, and the coordinate data of the point p₂₂ is “x₂₂, y₂₂, z₂₂” and the coordinate data of the point p₂₃ is “x₂₃, y₂₃, z₂₃”.

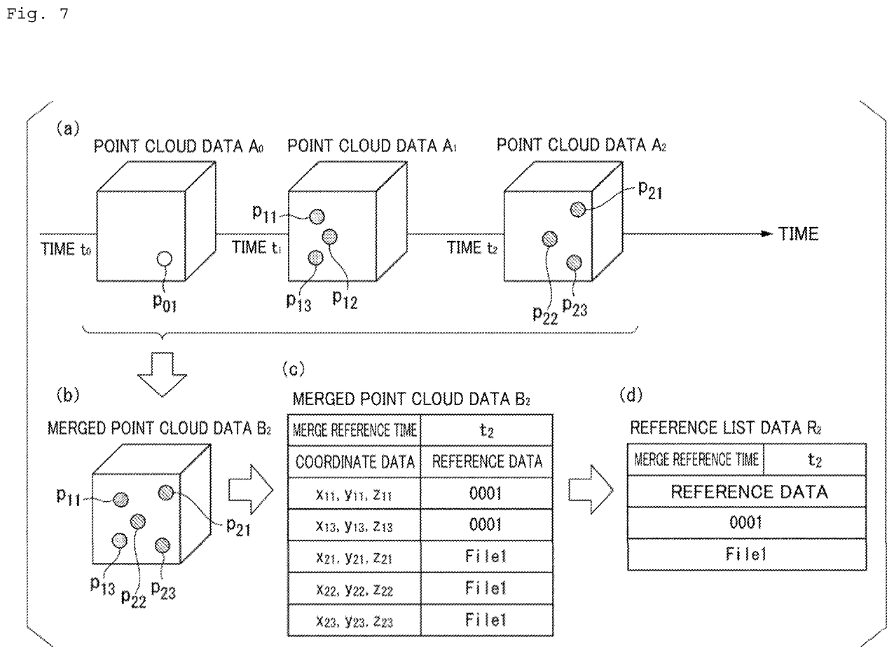

The merged point cloud data B₁ is point cloud data obtained by merging the point cloud data A₀ and the point cloud data A₁, as described above. FIG. 7(a) is a diagram in which the point cloud data A₀, the point cloud data A₁, and the point cloud data A₂ are arranged in the time-series order. Here, it is assumed that the position of the coordinate data “x₀₁, y₀₁, z₀₁” of the point poi of the point cloud data A₀ exists in a predetermined range around the position of the coordinate data “x₂₃, y₂₃, z₂₃” of the point p₂₃ of the point cloud data A₂, and the position of the coordinate data “x₁₂, y₁₂, z₁₂” of the point p₁₂ of the point cloud data A₁ exists in a range of a predetermined size around the position of the coordinate data “x₂₂, y₂₂, z₂₂” of the point p₂₂ of the point cloud data A₂.

In this way, when a point that comes earlier in the time-series order exist within a range of a predetermined size around a point that comes later in the time-series order, the merged point cloud data generation unit 13 does not merge the coordinate data of the point that comes earlier in the time-series order but merges the coordinate data of the point that comes later in the time-series order. Therefore, as shown in FIG. 7(b), the merged point cloud data generation unit 13 merges the merged point cloud data B₁ and the point cloud data A₂ to generate merged point cloud data B₂ including the points p₁₁, p₁₃, p₂₁, p₂₂, and p₂₃. The merged point cloud data generation unit 13 generates the merged point cloud data B₂, for example, as follows.

The merged point cloud data generation unit 13 deletes the pieces of coordinate data “x₀₁, y₀₁, z₀₁” and “x₁₂, y₁₂, z₁₂” that are not to be merged, and the corresponding pieces of reference data “DATA1” and “0001” from the merged point cloud data B₁. The merged point cloud data generation unit 13 adds and writes “x₂₁, y₂₁, z₂₁”, “x₂₂, y₂₂, z₂₂”, and “x₂₃, y₂₃, z₂₃” which are the pieces of coordinate data of the points p₂₁, p₂₂, and p₂₃ of the merging target point cloud data A₂ in the “coordinate data” item of the merged point cloud data B₁ so that they are on the row after the already-written coordinate data “x₁₁, y₁₁, z₁₁” and “x₁₃, y₁₃, z₁₃”.

The merged point cloud data generation unit 13 writes “File1”, which is the reference data of the respective pieces of coordinate data of the points p₂₁, p₂₂, and p₂₃ added to the “coordinate data” item, to the corresponding “reference data” item. The merged point cloud data generation unit 13 rewrites the “merge reference time” item of the merged point cloud data B₁ to the time “t₂” indicated by the measurement time data included in the point cloud data A₂. In this manner, the merged point cloud data generation unit 13 generates the merged point cloud data B₂ shown in FIG. 7(c) from the merged point cloud data B₁ (step Sa6).

After generating the merged point cloud data Bₙ, the merged point cloud data generation unit 13 deletes the merged point cloud data Bₙ₋₁ stored in the merged point cloud data storage unit 14, and writes the generated merged point cloud data Bₙ in the merged point cloud data storage unit 14. As a result, the merged point cloud data stored in the merged point cloud data storage unit 14 is replaced with the merged point cloud data Bₙ from the merged point cloud data Bₙ₋₁. After completing the writing of the merged point cloud data Bₙ in the merged point cloud data storage unit 14, the merged point cloud data generation unit 13 outputs a reference list generation start signal to the reference list generation unit 15 (step Sa7).

Upon receiving the reference list generation start signal from the merged point cloud data generation unit 13, the reference list generation unit 15 reads the merged point cloud data Bₙ from the merged point cloud data storage unit 14. The reference list generation unit 15 refers to the read merged point cloud data Bₙ to generate reference list data Rₙ. In the case of n=2, as shown in FIG. 7(d), the reference list generation unit 15 writes the time “t₂” written in the “merge reference time” item of the merged point cloud data B₂ to be referred to in the “merge reference time” item in the data format of the reference list data. The reference list generation unit 15 writes two pieces of data “0001” and “File1” which are the reference data written in the “reference data” item of the merged point cloud data B₂ to be referred to and which are different pieces of reference data in the “reference data” item in the time-series order. In this way, the reference list generation unit 15 generates the reference list data R₂.

After generating the reference list data Rn, the reference list generation unit 15 writes and stores the generated reference list data Rₙ in the reference list storage unit 16. After completing the writing of the reference list data Rₙ in the reference list storage unit 16, the reference list generation unit 15 outputs a reference list generation end signal to the merged point cloud data generation unit 13 (step Sa8).

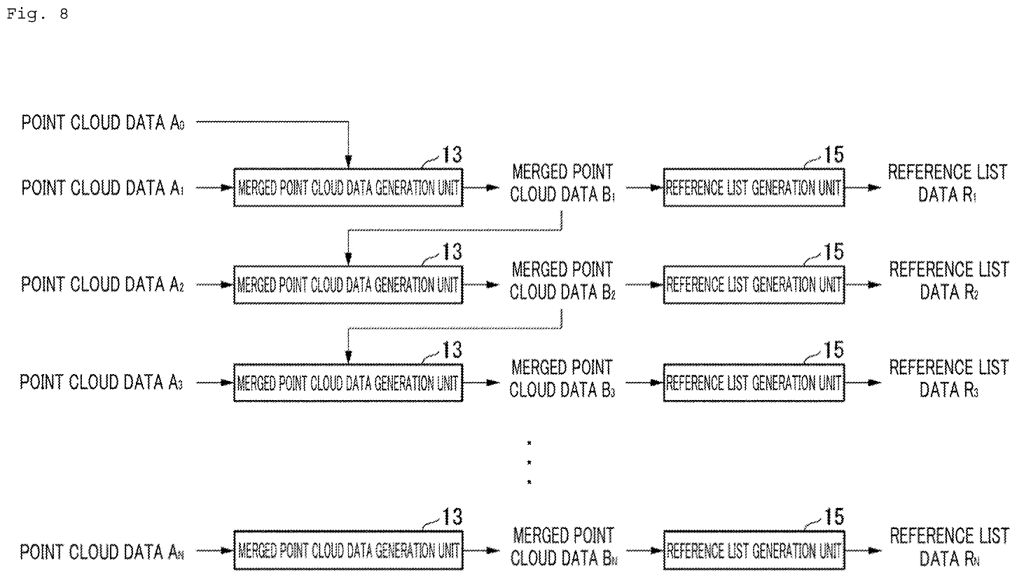

Upon receiving the reference list generation end signal from the reference list generation unit 15, the merged point cloud data generation unit 13 adds “1” to the value of “n” at that time to obtain a new value of “n”, and, as shown in FIG. 8, the processing of steps Sa6 to Sa8 is repeated until n=N (loop La1s to La1e). The processing ends when “n” becomes “N+1”. When the processing ends, the reference list storage unit 16 stores the reference list data R₁ to R_{N}, and the merged point cloud data storage unit 14 stores the merged point cloud data B_{N} last generated by the merged point cloud data generation unit 13.

### (Processing When Adding One Piece of New Point Cloud Data in First Embodiment)

The point cloud data acquisition unit 11 receives an operation of the user of the point cloud data processing device 1 and acquires one piece of new point cloud data A_{M} designated by the user from the measuring device. The point cloud data acquisition unit 11 writes and stores the acquired point cloud data A_{M} in the point cloud data storage unit 12.

The merged point cloud data generation unit 13 receives the operation of the user of the point cloud data processing device 1 to acquire generation instruction data including the individual merges information associated with the file name of the newly added point cloud data A_{M} (step Sa1). The merged point cloud data generation unit 13 determines whether the information included in the acquired generation instruction data is information indicating merge all or information indicating individual merges (step Sa2).

As described above, since the generation instruction data includes information indicating individual merges, the merged point cloud data generation unit 13 determines that the information included in the generation instruction data is information indicating individual merges (step Sa2, individual merges).

The merged point cloud data generation unit 13 reads, from the point cloud data storage unit 12, the point cloud data A_{M} corresponding to the file name associated with the information indicating the individual merges included in the generation instruction data. The merged point cloud data generation unit 13 reads the merged point cloud data B_{N} stored in the merged point cloud data storage unit 14, and reads the time written in the “merge reference time” item of the read merged point cloud data B_{N}. Here, it is assumed that the time written in the “merge reference time” item of the merged point cloud data B_{N} is “t_{N}”. The merged point cloud data generation unit 13 reads the measurement time data included in the point cloud data A_{M}. Here, it is assumed that the time indicated by the measurement time data included in the point cloud data A_{M} is “t_{M}”.

The merged point cloud data generation unit 13 determines whether the merge reference time “t_{N}” of the merged point cloud data B_{N} is before the time “t_{M}” indicated by the measurement time data of the point cloud data A_{M}, that is, t_{M}≥t_{N} (step Sa9).

Normally, the point cloud data A_{M} newly added to the point cloud data storage unit 12 is point cloud data generated at a time later than the time t_{N}. However, for example, a case in which the user stores the point cloud data A_{M} generated at a time earlier than the time to in the measuring device, and a case in which the point cloud data A_{M} generated at a time earlier than the time ty may be recorded in the point cloud data storage unit 12 are assumed. In such a case, it is necessary to generate the reference list data to be stored in the reference list storage unit 16 again. Therefore, when it is determined that the merge reference time “t_{N}” of the merged point cloud data B_{N} is not before the time “t_{M}” indicated by the measurement time data of the point cloud data A_{M} included in the generation instruction data, that is, t_{M}<t_{N} (step Sa9, No), the merged point cloud data generation unit 13 outputs an error message indicating that point cloud data whose measurement time is earlier than the merge reference time of the latest merged point cloud data B_{N} has been added, and prompt the user to generate the reference list data again (step Sa10).

When the user refers to the output error message and determines that it is necessary to generate the reference list data again, the user provides the merged point cloud data generation unit 13 with generation instruction data including information indicating merge all again. As a result, the processing of steps Sa3 to Sa8 is performed, and the reference theory list data in the correct time-series order in which the point cloud data A_{M} is added is generated. On the other hand, if the user refers to the output error message and determines that there is no need to generate the reference list data again, the point cloud data A_{M} that was erroneously recorded in the point cloud data storage unit 12 is deleted from the point cloud data storage unit 12.

On the other hand, when it is determined that the merge reference time “t_{N}” of the merged point cloud data B_{N} is before the time “t_{M}” indicated by the measurement time data of the point cloud data A_{M}, that is, t_{M}≥t_{N} (step Sa9, Yes), the merged point cloud data generation unit 13 merges the merged point cloud data B_{N} and the point cloud data A_{M} to generate new merged point cloud data B_{M} (step Sa11). Here, t_{M}=t_{N} is included as the determination criterion in step Sa9 because, even if the point cloud data of the same time as the merge reference time “t_{N}” of the merged point cloud data B_{N} is merged with the merged point cloud data B_{N}, the time-series order of the reference data written in the “reference data” item of the merged point cloud data B_{N} is maintained in the correct order.

After generating the merged point cloud data B_{M}, the merged point cloud data generation unit 13 deletes the merged point cloud data B_{N} stored in the merged point cloud data storage unit 14, and writes the generated merged point cloud data B_{M} in the merged point cloud data storage unit 14. As a result, the merged point cloud data stored in the merged point cloud data storage unit 14 is replaced with the merged point cloud data B_{M} from the merged point cloud data B_{N}. After completing the writing of the merged point cloud data B_{M} in the merged point cloud data storage unit 14, the merged point cloud data generation unit 13 outputs a reference list generation start signal to the reference list generation unit 15 (step Sa12).

Upon receiving the reference list generation start signal from the merged point cloud data generation unit 13, the reference list generation unit 15 reads the merged point cloud data B_{M} from the merged point cloud data storage unit 14. The reference list generation unit 15 refers to the read merged point cloud data B_{M} to generate reference list data R_{M} in the same procedure as the processing of steps Sa5 and Sa8. After generating the reference list data R_{M}, the reference list generation unit 15 writes and stores the generated reference list data R_{M} in the reference list storage unit 16 (step Sa13), and then ends the processing.

### (Point Cloud Data Generation Processing in First Embodiment)

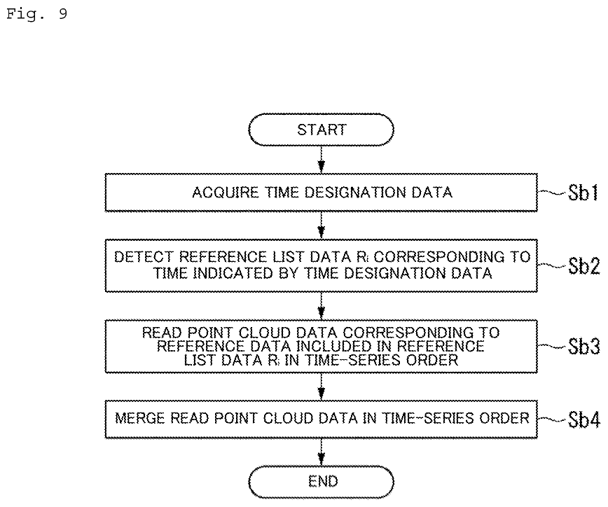

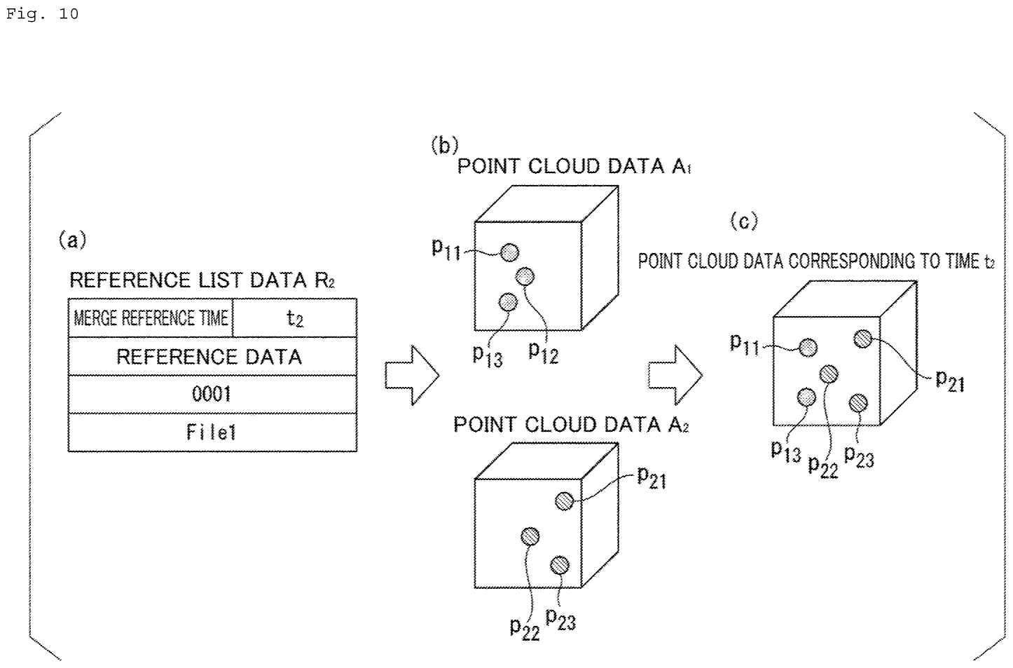

Next, processing by the point cloud data generation unit 17 will be described with reference to FIGS. 9 and 10. FIG. 9 is a flowchart showing the flow of processing by the point cloud data generation unit 17. It is assumed that the processing shown in FIG. 5 has been completed before the processing shown in FIG. 9 is performed, and the reference list storage unit 16 stores at least N pieces of reference list data R₁ to R_{N}. The point cloud data generation unit 17 receives the operation of the user of the point cloud data processing device 1 to acquire the time designation data designated by the user (step Sb1).

The point cloud data generation unit 17 detects reference list data Rᵢ in which a time matching the time indicated by the acquired time designation data or a time closest to the time is written in the “merge reference time” item from the reference list storage unit 16 as reference list data corresponding to the time indicated by the acquired time designation data (step Sb2). Here, i is any integer from 1 to N. Note that if there are two or more pieces of reference list data Rᵢ in which the time closest to the time indicated by the time designation data is written in the “merge reference time” item at a time before or after the time indicated by the time designation data, the point cloud data generation unit 17 may select any one of them, or may output a message to prompt the user to select any one of them.

Here, it is assumed that the time indicated by the time designation data acquired by the point cloud data generation unit 17 is “t₂”, and the point cloud data generation unit 17 has detected the reference list data R₂ in which “t₂” is written in the “merge reference time” item shown in FIG. 10(a) from the reference list storage unit 16.

The point cloud data generation unit 17 sequentially selects the reference data written in the “reference data” item of the detected reference list data Rᵢ from the first row to the last row, and reads the point cloud data corresponding to the respective pieces of reference data from the point cloud data storage unit 12 in the order of the selected pieces of reference data. As a result, the point cloud data generation unit 17 acquires the pieces of point cloud data arranged in the time-series order (step Sb3). In the case of the reference list data R₂, the point cloud data generation unit 17 first reads the point cloud data A₁ whose file name corresponding to the reference data “0001” in the first row of the “reference data” item is “Pointcloud_0001” from the point cloud data storage unit 12. Next, the point cloud data generation unit 17 reads the point cloud data A₂ whose file name corresponding to the reference data “File1” on the second row of the “reference data” item is “Pointcloud File1” from the point cloud data storage unit 12.

The point cloud data generation unit 17 merges the pieces of read point cloud data in the time-series order, similarly to the merging processing performed by the merged point cloud data generation unit 13, to generate point cloud data corresponding to the time indicated by the time designation data (step Sb4). In the case of the reference list data R₂, the point cloud data generation unit 17 reads the point cloud data A₁ and the point cloud data A₂ as shown in FIG. 10(b).

The point p12 of the point cloud data A₁ exists in a range of a predetermined size around the position of the point p22 of the point cloud data A₂. Therefore, when merging the point cloud data A₁ and the point cloud data A₂, the point cloud data generation unit 17 selects the point p22 that comes later in the time-series order as a merging target, and generates the point cloud data including the points p₁₁, p₁₃, p₂₁, p₂₂, and p₂₃ as the point cloud data corresponding to time t₂ as shown in FIG. 10(c).

In the point cloud data processing device 1 of the first embodiment described above, the point cloud data storage unit 12 stores a plurality of pieces of point cloud data measured at an arbitrary measurement time at a plurality of measurement positions in a three-dimensional space. The merged point cloud data generation unit 13 generates merged point cloud data including the point cloud data corresponding to any one of measurement times, location data indicating the location of a point when pieces of point cloud data measured before the measurement time are integrated in the time-series order, that is, the coordinate data indicating the position of the point, and reference data assigned to each piece of location data, for specifying the point cloud data in which the point indicated by the location data is included in the time-series order tbased on the point cloud data stored in the point cloud data storage unit 12. The reference list generation unit 15 selects different pieces of reference data in the time-series order from the reference data included in the merged point cloud data generated by the merged point cloud data generation unit 13, and generates reference list data including the pieces of reference data selected in the time-series order for each of the measurement times of the plurality of pieces of point cloud data.

By merging all pieces of point cloud data of a time before the time indicated by the time designation data given to the point cloud data generation unit 17, it is possible to generate the point cloud data corresponding to the time indicated by the time designation data. However, in this case, as the time indicated by the time designation data becomes newer, the number of pieces of point cloud data to be merged increases, and the time required for merging increases. In contrast, in the point cloud data processing device 1 of the first embodiment, reference list data indicating the point cloud data to be merged and the order of merging is generated in advance for each measurement time of the point cloud data, and the reference list data is generated whenever point cloud data is added. Therefore, when it is desired to generate point cloud data corresponding to an arbitrary time, it is possible to specify point cloud data required for merging and the order of merging by selecting the reference list data corresponding to an arbitrary time from the generated reference list data. Therefore, in the point cloud data processing device 1 of the first embodiment, it is possible to shorten the time required for integrating a plurality of pieces of point cloud data acquired at an arbitrary time and arbitrary measurement positions.

Further, the point cloud data processing device 1 of the first embodiment described above has the following advantages. As described above, data indicating the locations of points in an arbitrary region and at an arbitrary times can be generated by merging a plurality of pieces of point cloud data. However, in this case, it is not efficient to store data indicating the locations of all combinations of points. In addition, sensor data such as point cloud data accumulates over time, and the volume continues to increase. Therefore, according to a conventional method of handling sensor data, the sensor data is discarded after the required feature amount is extracted and the required processing is performed. Regarding the merged point cloud data generated by the point cloud data processing device 1 of the first embodiment, from the viewpoint of such a conventional method of handling sensor data, it is common practice to discard the original point cloud data after generating the merged point cloud data in an arbitrary region and at an arbitrary time. In contrast, the point cloud data processing device 1 of the first embodiment described above is configured such that rather than storing data indicating the locations of points in an arbitrary region and at an arbitrary time, that is, the merged point cloud data itself, the original point cloud data is stored, and then, the relationship of the point cloud data constituting the data indicating the locations of points in an arbitrary region and at an arbitrary time is stored as reference list data. With such a configuration, in the first embodiment, in addition to making it possible to shorten the processing time as described above, since the original point cloud data and the reference list data are stored, it is not necessary to store data indicating the locations of all combinations of points. In addition, the configuration of the first embodiment is advantageous over the conventional method in that the desired point cloud data can be generated from the stored original point cloud data, for example, even when the merging method is changed in accordance with the change in conditions such as the purpose of use is changed.

### Second Embodiment

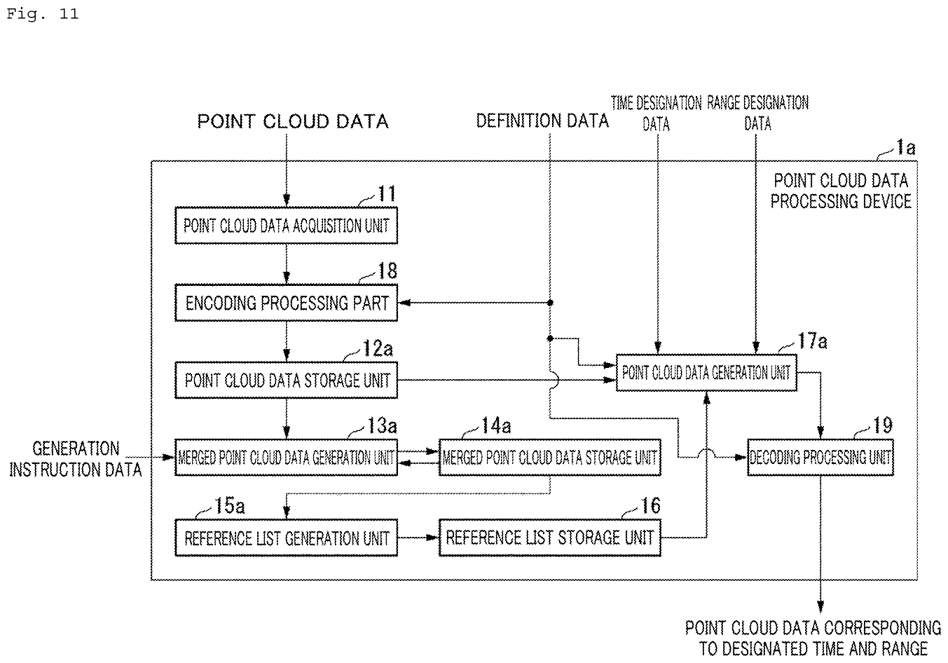

FIG. 11 is a block diagram showing the configuration of a point cloud data processing device 1a according to the second embodiment. In the second embodiment, identical configurations to the first embodiment have been allocated identical reference signs, and only different configurations will be described below. The point cloud data processing device 1a includes a point cloud data acquisition unit 11, an encoding processing unit 18, a point cloud data storage unit 12a, a merged point cloud data generation unit 13a, a merged point cloud data storage unit 14a, a reference list generation unit 15a, a reference list storage unit 16, a point cloud data generation unit 17a, and a decoding processing unit 19.

The encoding processing unit 18 is, for example, an encoder that generates encoded point cloud data by obtained by octree-encoding the point cloud data. When the encoding processing unit 18 receives the operation of the user of the point cloud data processing device 1a to acquire the definition data designated by the user, the encoding processing unit 18 performs octree encoding processing on the point cloud data acquired and output by the point cloud data acquisition unit 11 according to the acquired definition data.

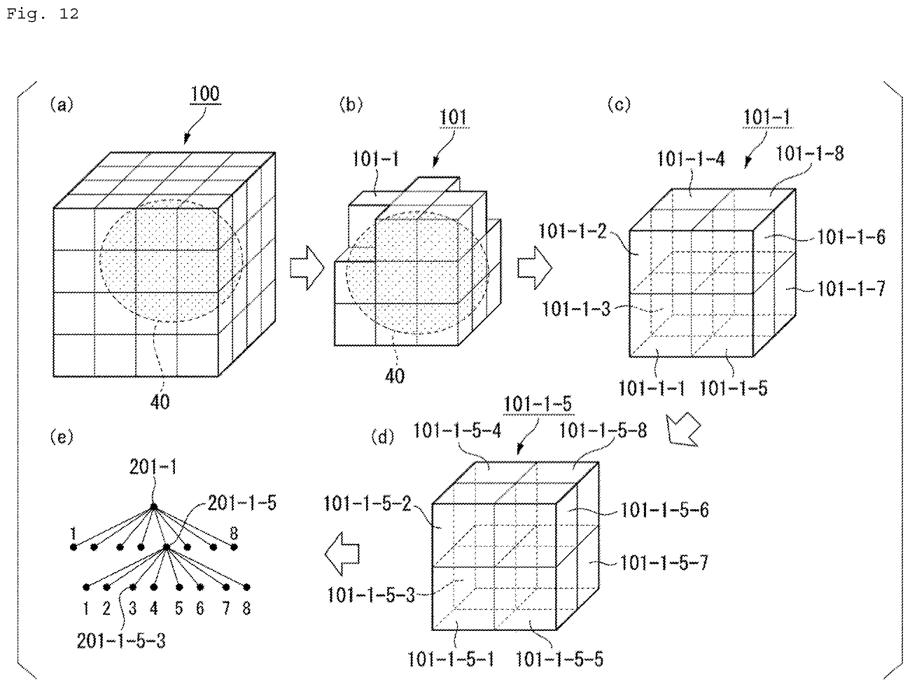

The octree encoding processing performed by the encoding processing unit 18 will be described with reference to FIG. 12. As shown in FIG. 12(a), it is assumed that a three-dimensional space indicated by reference sign 100 (hereinafter referred to as a three-dimensional space 100) is divided into cubes of the same size without gaps. Each of these cubes is hereinafter referred to as a tile. Although FIG. 12(a) shows the three-dimensional space 100 with thirty six (36=4×4×4) tiles, it is assumed that the tiles continue infinitely in the vertical and horizontal directions.

The positions of the tiles are represented, for example, by coordinate values of a three-dimensional coordinate system of X, Y, and Z-axes determined in advance in the three-dimensional space 100. Specifically, the position of one predetermined vertex of a cube, which is the shape of a tile, or the position of the center of the cube is defined as a tile reference position indicating the position of the tile. In the definition data acquired by the encoding processing unit 18, coordinate data indicating the tile reference position of each tile (hereinafter referred to as tile reference position data) and data indicating the size of the tile, that is, the length of one side of the cubes that constitute one tile are defined. The encoding processing unit 18 can specify the tile reference position of each tile and the size of one tile by referring to the definition data.

Each point included in the point cloud data output by the point cloud data acquisition unit 11 exists at any position in the three-dimensional space 100, and the range in which this point cloud data exists is the range indicated by reference sign 40 (this point cloud data is hereinafter referred to as point cloud data 40). The encoding processing unit 18 selects a tile group 101 including all or part of the range of the point cloud data 40, as shown in FIG. 12(b). Since the point cloud data 40 has various shapes, the shape of the tile group 101 selected by the encoding processing unit 18 is a shape corresponding to the shape of the point cloud data 40. As shown in FIG. 12(b), when the shape of the tile group 101 is a shape in which the top three tiles are missing from 3×3×3 tiles, the tile group 101 includes 24 tiles. The encoding processing unit 18 performs octree encoding described below on each of the 24 tiles included in the tile group 101.

For example, when the encoding processing unit 18 performs octree encoding on a tile 101-1, which is one tile included in the tile group 101, the tile 101-1 is divided into 8 equal-sized cubes by halving each side. Each cube obtained by dividing a tile into eight is hereinafter referred to as a block, and each cube obtained by further dividing a block described below into eight is also referred to as a block. The tile 101-1 is divided into eight blocks 101-1-1 to 101-1-8.

The encoding processing unit 18 further divides a block which includes any point of the point cloud data 40 among the blocks 101-1-1 to 101-1-8 into eight. For example, when the block 101-1-5 includes any point of the point cloud data 40, the encoding processing unit 18 further divides the block 101-1-5 into eight, as shown in FIG. 12(d). In this way, the encoding processing unit 18 recursively repeats dividing the block including the points of the point cloud data 40 into eight until one point is included in the block and the position of the one point becomes the position of a representative point of the block. Here, the position of the representative point of the block is, for example, the position of the center of the block.

As shown in FIG. 12(d), it is assumed that the encoding processing unit 18 further divides the block 101-1-5 into eight, and the block 101-1-5-3, which is one of the eight divided blocks includes one point, and the position of the one point becomes the position of the representative point of the block 101-1-5-3. In this case, the positions of the points included in the block 101-1-5-3 can be expressed by an octree structure whose root is a root node 201-1 corresponding to the tile 101-1 as shown in FIG. 12(e).

The block 101-1-5-3 is a block 101-1-5, which is the fifth block of the tile 101-1, and is also the third block of the block 101-1-5. If this position is expressed by an 8-bit string with 1 at the position of the block where a point exists, an internal node 201-1-5 corresponding to the block 101-1-5 on the first layer is expressed as [00010000] where the fifth bit is 1. A leaf node 201-1-5-3 corresponding to the block 101-1-5-3 on the second layer is expressed as [00000100] where the third bit is 1. [00010000] on the first layer is expressed as “16” in decimal. [00000100] on the second layer is expressed as “4” in decimal.

Actually, since there are many points included in the point cloud data 40, points will exist in some of the blocks 101-1-1 to 101-1-8 on the first layer, and points will exist in some of the blocks on each layer of the second and lower layers. For example, if points exist in all of the blocks 101-1-1 to 101-1-8 on the first layer, the bit string will be “11111111”, which is “255” in decimal. Therefore, when the location of a point on the first layer is expressed in decimal, the location is expressed as any value from 1 to 255. The location of a point on the second and lower layers is also expressed as any value from 1 to 255, as in the first layer. In this way, the locations of all the points in the point cloud data 40 can be expressed as a combination of any value from 1 to 255 by repeating expressing the internal nodes or leaf nodes on each layer up to the bottom layer with any value from 1 to 255.

The encoding processing unit 18 performs variable-length encoding on a combination of values of 1 to 255 sequentially from the first layer to generate encoded data (hereinafter referred to as octree-encoded data) of octree encoding for the tile 101-1. In G-pcc, when octree encoding is performed on a certain block, an encoding table is switched according to the state of the octree encoding of neighboring encoded blocks to perform octree encoding. Therefore, when the encoding processing unit 18 performs octree encoding according to the G-pcc specification, it is necessary to consider blocks that do not include a point, that is, nodes with the value of “0”, and a combination of values from 0 to 255 including 0 is variable-length encoded sequentially from the first layer. The encoding processing unit 18 can generate encoded point cloud data for the point cloud data 40 by performing the above-described octree encoding on all tiles included in the tile group 101. The encoded point cloud data generated by the encoding processing unit 18 is data whose data amount is reduced compared to the coordinate data representing the points of the point cloud data 40 output by the point cloud data acquisition unit 11.

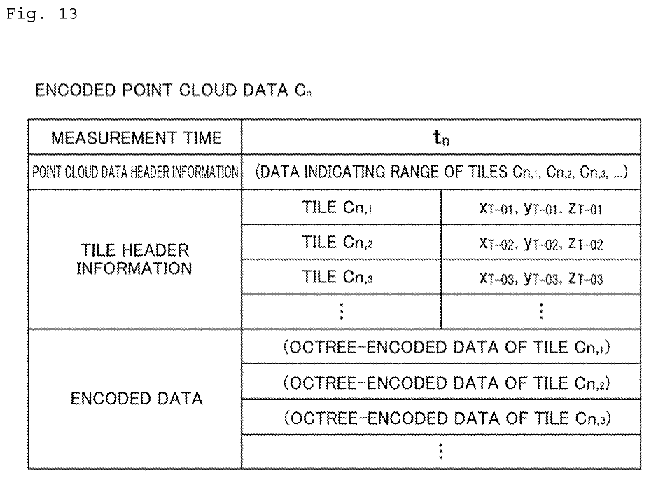

For example, upon acquiring the point cloud data Aₙ output by the point cloud data acquisition unit 11, the encoding processing unit 18 generates the encoded point cloud data Cₙ in the data format shown in FIG. 13 by the above-described octree encoding. Here, n is any integer from 0 to N. The encoded point cloud data Cₙ has items of “measurement time”, “point cloud data header information”, “tile header information”, and “encoded data”.

The time indicated by the measurement time data included in the point cloud data Aₙ is written in the “measurement time” item. Data indicating the range of a tile group including all or part of the range of the point cloud data 40 is written in the “point cloud data header information” item. Tile identification information such as “tile C_{n,1}” that can identify each tile that has been octree-encoded by the encoding processing unit 18, and tile reference position data such as (x_{T-01}, y_{T-01}, z_{T-01}), which are coordinate values indicating the position of the tile indicated by the tile identification information, are written in the “tile header information” in association with each other.

Octree-encoded data for each tile, which is octree-encoded by the encoding processing unit 18, is written in the “encoded data” item. Each piece of octree-encoded data is associated with tile identification information in the “tile header information” item, and the octree-encoded data corresponding to “tile C_{n,1}” of the “encoded data” item can be detected by designating the tile identification information “tile C_{n,1}” in the encoded point cloud data Cₙ, for example.

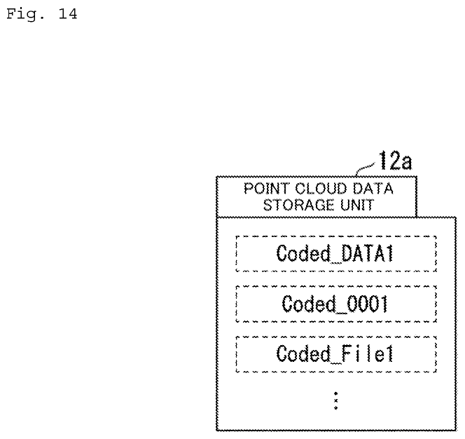

The point cloud data storage unit 12a stores the encoded point cloud data generated by the encoding processing unit 18. As shown in FIG. 14, the point cloud data storage unit 12a stores a plurality of pieces of encoded point cloud data in a file format. FIG. 14 shows an example in which the point cloud data storage unit 12 stores encoded point cloud data files with file names “Coded_DATA1”, “Coded_0001”, and “Coded_File1”, respectively. For example, it is assumed that “Coded_DATA1” is the file name of the encoded point cloud data obtained by octree encoding the point cloud data whose file name is “Pointcloud_DATA1” in the first embodiment, “Coded_0001” is the file name of the encoded point cloud data obtained by octree encoding the point cloud data whose file name is “Pointcloud_0001” in the first embodiment, and “Coded_File1” is the file name of the encoded point cloud data obtained by octree encoding the point cloud data whose file name is “Pointcloud_File1” in the first embodiment.

Upon receiving the generation instruction data including the information indicating merge all, the merged point cloud data generation unit 13a arranges pieces of encoded point cloud data in the time-series order by referring to the time written in the “measurement time” item of all pieces of encoded point cloud data stored in the point cloud data storage unit 12a. The merged point cloud data generation unit 13a repeats merging of encoded point cloud data one by one in the time-series order with respect to the leading encoded point cloud data in the time-series order to generate merged point cloud data whenever one piece of encoded point cloud data is merged. Upon receiving generation instruction data including information indicating individual merges associated with the file name of one piece of encoded point cloud data, the merged point cloud data generation unit 13a merges the encoded point cloud data of a file name associated with the information indicating individual merges included in the generation instruction data with merged point cloud data that has already been generated to generate new merged point cloud data.

The merged point cloud data storage unit 14a stores the merged point cloud data generated by the merged point cloud data generation unit 13a. The reference list generation unit 15a generates reference list data from the merged point cloud data stored in the merged point cloud data storage unit 14a. The data format of the reference list data generated by the reference list generation unit 15a is the same as the data format of the reference list data generated by the reference list generation unit 15 of the first embodiment shown in FIG. 4.

The point cloud data generation unit 17a receives the operation of the user of the point cloud data processing device 1a to acquire the definition data, the time designation data, and the range designation data designated by the user. The point cloud data generation unit 17a detects, from the reference list storage unit 16, the reference list data corresponding to the time indicated by the acquired time designation data. The point cloud data generation unit 17a reads the encoded point cloud data from the point cloud data storage unit 12a in the time-series order based on the reference data written in the “reference data” item of the detected reference list data. The point cloud data generation unit 17a merges encoded point cloud data including points within the range indicated by the range designation data among the pieces of read encoded point cloud data according to the acquired definition data. The point cloud data generation unit 17a merges pieces of encoded point cloud data to be merged in the time-series order to generate encoded point cloud data corresponding to the time designated by the time designation data and the range indicated by the range designation data.

The decoding processing unit 19 is, for example, a decoder that decodes the original point cloud data from the encoded point cloud data that has been octree-encoded. Upon receiving the operation of the user of the point cloud data processing device 1a to acquire the definition data designated by the user, the decoding processing unit 19 performs processing of decoding the original point cloud data from the encoded point cloud data generated by the point cloud data generation unit 17a according to the acquired definition data.

### (Processing of Generating Merged Point Cloud Data and Reference List Data in Second Embodiment)

The processing of generating merged point cloud data and reference list data in the second embodiment is performed on the premise that N+1 pieces of encoded point cloud data encoded by the encoding processing unit 18 are written in the point cloud data storage unit 12a. In the processing of generating merged point cloud data and reference list data in the second embodiment, the processing similar to the processing of generating merged point cloud data performed by the merged point cloud data generation unit 13 of the first embodiment shown in FIG. 5 is performed by the merged point cloud data generation unit 13a, and the processing similar to the processing of generating reference list data performed by the reference list generation unit 15 of the first embodiment is performed by the reference list generation unit 15a, except for the following differences.

The difference between the first embodiment and the second embodiment is that the point cloud data is merged in the first embodiment, whereas encoded point cloud data is merged in the second embodiment. In both the first embodiment and the second embodiment, the object to be merged is common in that it is data indicating the locations of points in the point cloud data. However, in the first embodiment, the merging processing is performed on the coordinate data indicating the position of a point of the point cloud data is performed. In contrast, in the second embodiment, the merging processing is performed on the data indicating the range written in the “point cloud data header information” item of the encoded point cloud data, the tile identification information and the tile reference position data written in the “tile header information” item, and the octree-encoded data written in the “encoded data” item.

In the processing of step Sa3 in the second embodiment, the merged point cloud data generation unit 13a performs processing of reading all pieces of encoded point cloud data, that is, N+1 pieces of encoded point cloud data from the point cloud data storage unit 12a and arranging pieces of encoded point cloud data in the time-series order by referring to the time written in the “measurement time” item of the read N+1 pieces of encoded point cloud data. Here, the N+1 pieces of encoded point cloud data arranged in the time-series order are denoted as encoded point cloud data C₀, C₁, . . . , C_{N}. As described above, the pieces of encoded point cloud data C₀, C₁, . . . , C_{N} are data obtained by the encoding processing unit 18 performing octree encoding on the pieces of point cloud data processing device A₀, A₁, . . . , A_{N}, respectively.

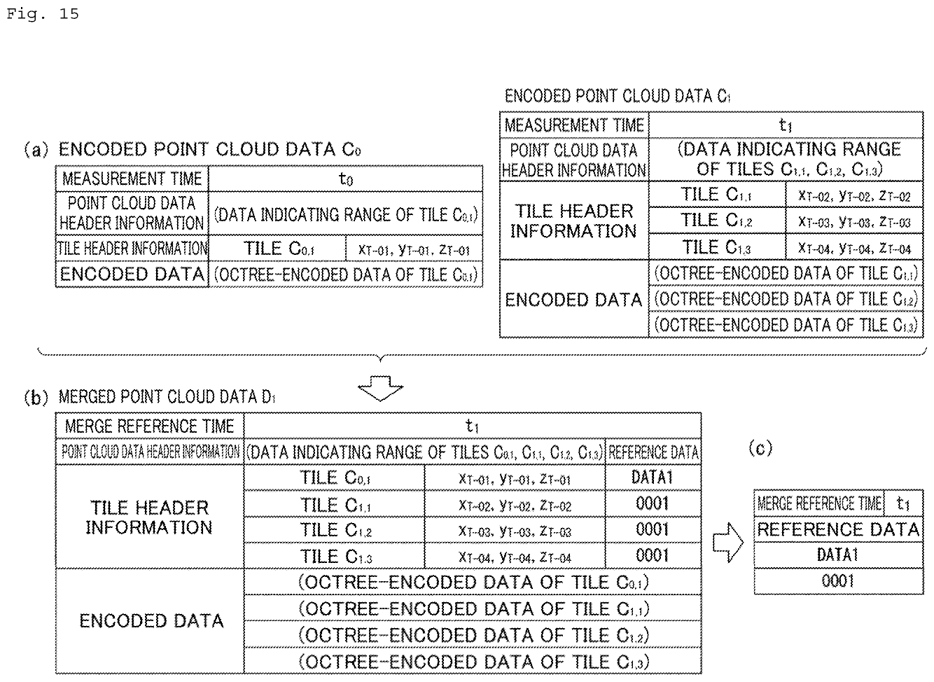

For example, it is assumed that the pieces of encoded point cloud data C₀, C₁ are the pieces of encoded point cloud data C₀, C₁ shown in FIG. 15(a), and t₁≥t₀. It is assumed that the file names of the pieces of encoded point cloud data C₀ and C₁ are “Coded_DATA1” and “Coded_0001”, respectively. In the processing of step Sa4 in the second embodiment, the merged point cloud data generation unit 13a performs processing of merging the pieces of encoded point cloud data C₀ and C₁ to generate the merged point cloud data Di shown in FIG. 15(b). As shown in FIG. 15(b), the merged point cloud data D₁ includes items of “merge reference time”, “point cloud data header information”, “tile header information”, “reference data”, and “encoded data”.

The time in the “measurement time” item of the encoded point cloud data merged last is written in the “merge reference time” item. Therefore, in the case of the merged point cloud data D₁, “t₁” written in the “measurement time” item of the encoded point cloud data C₁ is written. The data indicating the range of tiles C_{0,1}, C_{1,1}, C_{1,2}, C_{1,3} obtained by integrating the range of a tile C_{0,1} written in the “point cloud data header information” item of the encoded point cloud data C0 and the range of tiles C_{1,1}, C_{1,2}, C_{1,3} written in the “point cloud data header information” item of the encoded point cloud data C₁ is written in the “point cloud data header information” item. The tile identification information and the tile reference position data written in the “tile header information” item of the encoded point cloud data C₀ and the tile identification information and the tile reference position data written in the “tile header information” item of the encoded point cloud data C₁ are written in the “tile header information” item in the time-series order.

Reference data which is data capable of specifying which encoded point cloud data file includes each of the tiles C_{0,1}, C_{1,1}, C_{1,2}, and C_{1,3} specified by the tile identification information is written in the “reference data” item. FIG. 15(b) shows an example in which the character strings “DATA1” and “0001”, which are the remaining character strings excluding the common character string “Coded ” in the file names of the pieces of encoded point cloud data C₀ and C₁, are written as the reference data. The reference data may be any data as long as it can specify which encoded point cloud data file includes the tile. For example, the entire file name of the encoded point cloud data may be used as the reference data. The octree-encoded data written in the “encoded data” item of the encoded point cloud data C₀ and the octree-encoded data written in the “encoded data” item of the encoded point cloud data C₁ are written in the “encoded data” item.

In the processing of step Sa5 in the second embodiment, the reference list generation unit 15a performs processing of generating the reference list data R₁ shown in FIG. 15(c) from the “merge reference time” item and the “reference data” item of the merged point cloud data D₁. As shown in FIG. 15(c), the reference list generation unit 15a writes the time written in the “merge reference time” item of the merged point cloud data D₁ in the “merge reference time” item in the data format of the reference list data. The reference list generation unit 15a writes different pieces of reference data selected from the “tile header information” item of the merged point cloud data D₁ in the “reference data” item in the time-series order by the same procedure as the reference list generation unit 15 of the first embodiment. In this way, the reference list generation unit 15a generates the reference list data R₁. That is, information indicating which encoded point cloud data includes the point represented by the merged point cloud data D₁ at time t₁ is recorded in the reference list data R₁ generated by the reference list generation unit 15a.

The loop La1s to La1e in the second embodiment is repeated for each of the pieces of encoded point cloud data C₂ to C_{N}. In the processing of step Sa6 in the second embodiment, the merged point cloud data generation unit 13a merges the encoded point cloud data Cₙ and the merged point cloud data Dₙ₋₁ to generate the merged point cloud data Dₙ.

That is, the merged point cloud data generation unit 13a adds pieces of data written in the “tile header information” and “encoded data” items of the encoded point cloud data Cₙ to the “tile header information” and “encoded data” items of the merged point cloud data Dₙ₋₁, respectively, in the time-series order. The merged point cloud data generation unit 13a writes the reference data corresponding to the added tile identification information and tile reference position data in the corresponding row of the “reference data” item. The merged point cloud data generation unit 13a writes data indicating a range obtained by integrating the data indicating the range written in the “point cloud data header information” item of the merged point cloud data Dₙ₋₁ and the data indicating the range written in the “point cloud data header information” item of the encoded point cloud data Cₙ in the “point cloud data header information” item. The merged point cloud data generation unit 13a writes the time written in the “measurement time” item of the encoded point cloud data Cₙ to the “merge reference time” item. In this way, the merged point cloud data generation unit 13a generates new merged point cloud data Dₙ.

Note that when the merged point cloud data generation unit 13a merges the encoded point cloud data C₀ and the encoded point cloud data C₁ in the processing of step Sa4, and when the merged point cloud data generation unit 13a merges the merged point cloud data Dₙ₋₁ and the encoded point cloud data Cₙ in the processing of step Sa6, the tile reference position data written in the “tile header information” item of the two pieces of merging target data may indicate the same position. In this case, the merged point cloud data generation unit 13a selects the tile reference position data written in the “tile header information” item of the data that comes later in the time-series order and the tile identification information corresponding to the tile reference position data as a merging target. The merged point cloud data generation unit 13a further selects the octree-encoded data corresponding to the tile identification information to be merged as a merging target. The merged point cloud data generation unit 13a generates merged point cloud data so as to include the tile reference position data, the tile identification information, and the octree-encoded data selected as a merging target.

For example, it is assumed that the tile reference position data of the tile C_{1,1} of the encoded point cloud data C₁ in FIG. 15(a) is not (x_{T-02}, y_{T-02}, z_{T-02}) but is (x_{T-01}, y_{T-01}, z_{T-01}) the same as the tile reference position data of the tile C_{0,1} of the encoded point cloud data C₀. In this case, in the “tile header information” item of the merged point cloud data D₁ generated by the merged point cloud data generation unit 13a, the tile identification information of the tile C₀, and the tile reference position data (x_{T-01}, y_{T-01}, z_{T-01}) corresponding to the tile identification information will not be included, the reference data “DATA1” of the “reference data” item will not be included, and the octree-encoded data of the tile C_{0,1} of the “encoded data” item will not be included. The “point cloud data header information” item will be data indicating the range of the tiles C_{1,1}, C_{1,2}, C_{1,3}.

In the processing of step Sa7 in the second embodiment, the merged point cloud data generation unit 13a replaces the merged point cloud data Dₙ₋₁ stored in the merged point cloud data storage unit 14a with the newly generated merged point cloud data Dₙ. In the processing of step Sa8 in the second embodiment, the reference list generation unit 15a generates reference list data Rₙ from the merged point cloud data Dₙ stored in the merged point cloud data storage unit 14a. This processing is performed by the same procedure as the processing in which the merged point cloud data generation unit 13a generates the reference list data R₁ from the merged point cloud data D₁.

When the user of the point cloud data processing device 1a provides generation instruction data including information indicating individual merges to the merged point cloud data generation unit 13a, a file name of the encoded point cloud data C_{M} newly added to the point cloud data storage unit 12a is associated with the information indicating individual merges. Here, the encoded point cloud data C_{M} is, for example, encoded point cloud data obtained by the encoding processing unit 18 performing octree encoding on the point cloud data A_{M}. In the processing of step Sa9 in the second embodiment, the merged point cloud data generation unit 13a determines whether the time written in the “merge reference time” item of the merged point cloud data D_{N} is a time that is before the time written in the “measurement time” item of the encoded point cloud data CM. The processing of steps Sa11 to Sa13 in the second embodiment is performed in the same procedure as the processing of steps Sa6 to Sa8 in the above-described second embodiment.

That is, in the processing of step Sa11 in the second embodiment, the merged point cloud data generation unit 13a performs processing of merging the merged point cloud data D_{N} stored in the merged point cloud data storage unit 14a with the encoded point cloud data C_{M} to generate merged point cloud data D_{M}. In the processing of step Sa12 in the second embodiment, the merged point cloud data generation unit 13a performs processing of replacing the merged point cloud data D_{N} stored in the merged point cloud data storage unit 14a with the newly generated merged point cloud data D_{M}. In the processing of step Sa13 in the second embodiment, the reference list generation unit 15a performs processing of generating reference list data Ry from the merged point cloud data D_{M}.

### (Point Cloud Data Generation Processing in Second Embodiment)

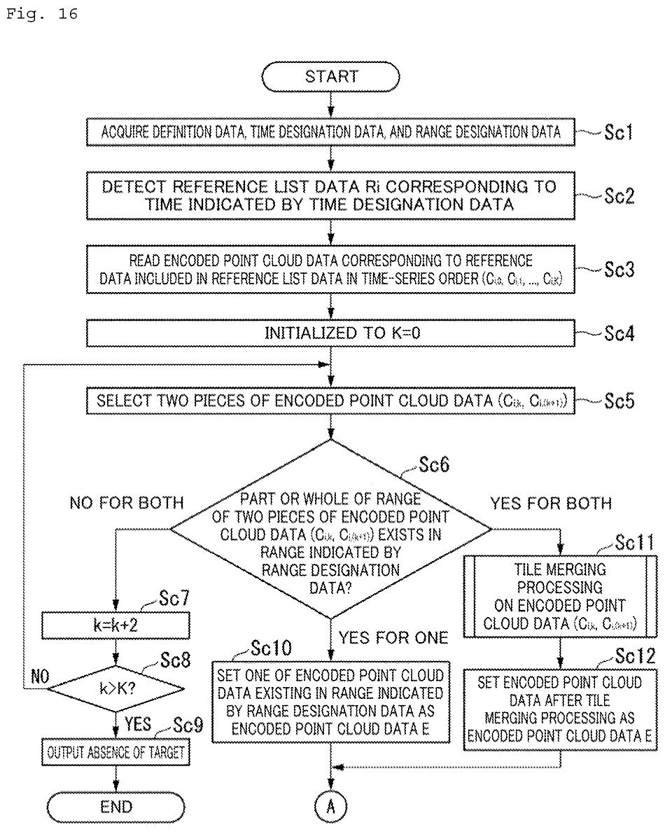

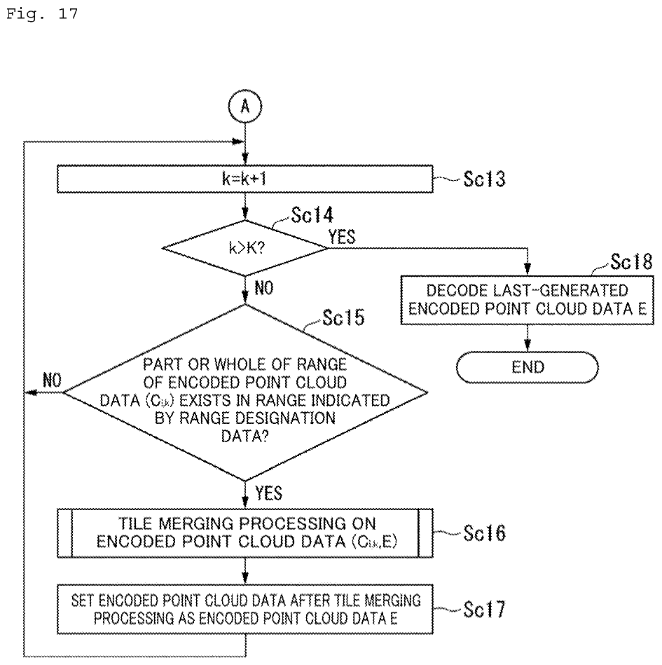

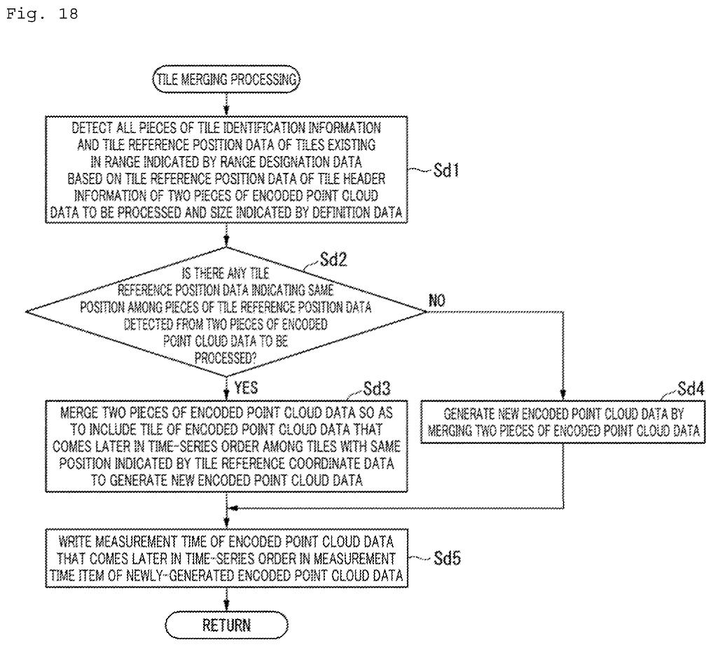

Next, processing by the point cloud data generation unit 17a and the decoding processing unit 19 will be described with reference to FIGS. 16 to 20. FIGS. 16 and 17 are flowcharts showing the flow of processing by the point cloud data generation unit 17a and the decoding processing unit 19. FIG. 18 is a flowchart showing the flow of processing of a subroutine of the tile merging processing performed in the processing shown in FIGS. 16 and 17.

It is assumed that the processing of generating the merged point cloud data and the reference list data in the above-described second embodiment is completed before the processing shown in FIG. 16 is performed, and the reference list storage unit 16 stores at least N pieces of reference list data R₁ to R_{N}.

The point cloud data generation unit 17a and the decoding processing unit 19 receive the operation of the user of the point cloud data processing device 1a to acquire the definition data designated by the user. Further, the point cloud data generation unit 17a receives the operation of the user of the point cloud data processing device 1a to acquire the time designation data and the range designation data designated by the user (step Sc1).

The point cloud data generation unit 17a detects reference list data Rᵢ in which a time matching the time indicated by the acquired time designation data or a time closest to the time is written in the “merge reference time” item from the reference list storage unit 16 as the reference list data corresponding to the time indicated by the acquired time designation data (step Sc2). Here, i is any integer from 1 to N. Note that if two or more pieces of reference list data items Rᵢ in which the time closest to the time indicated by the time designation data is written in the “merge reference time” item exist at a time before or after the time indicated by the time designation data, the point cloud data generation unit 17a may select any one of them, or may output a message to prompt the user to select any one of them.

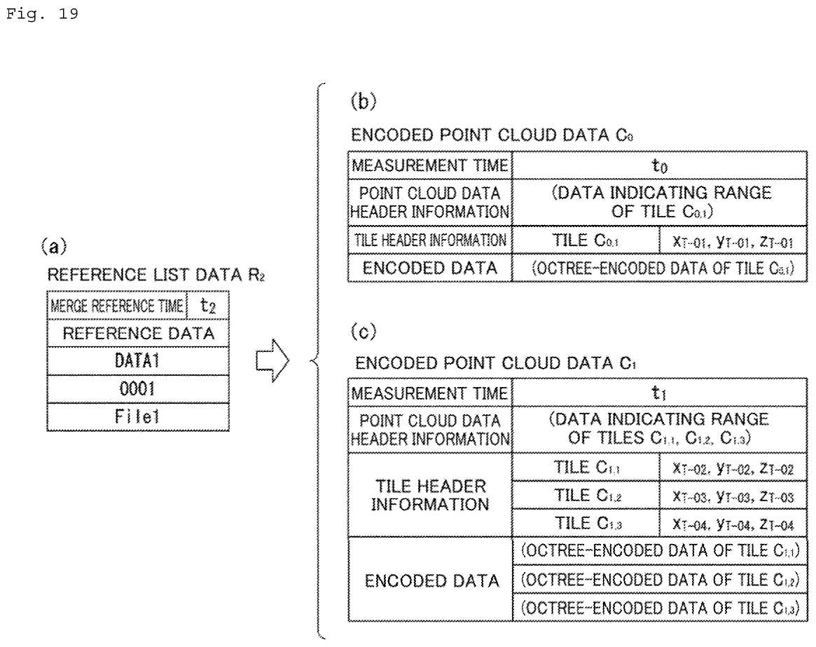

Here, it is assumed that the time indicated by the time designation data acquired by the point cloud data generation unit 17a is “t₂”, and the point cloud data generation unit 17a has detected the reference list data R₂ in which “t₂” is written in the “merge reference time” item shown in FIG. 19(a) from the reference list storage unit 16.

The point cloud data generation unit 17a reads the encoded point cloud data corresponding to the reference data written in the “reference data” item of the detected reference list data R₁ from the point cloud data storage unit 12a in the time-series order (step Sc3). The pieces of encoded point cloud data read from the point cloud data storage unit 12a by the point cloud data generation unit 17a in the time-series order are denoted as encoded point cloud data Ci,0, Ci,1, . . . , Ci,K. Here, K is an integer of 0 or more.

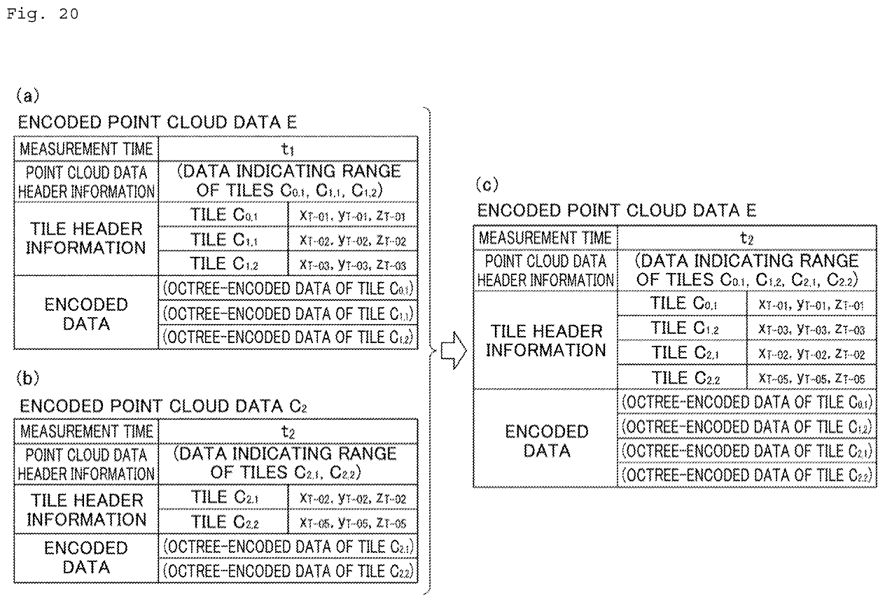

In the case of the reference list data R₂, the point cloud data generation unit 17a first reads the encoded point cloud data C₀ with the file name “Coded DATA1” corresponding to the reference data “DATA1” on the first row of the “reference data” item from the point cloud data storage unit 12a. Next, the point cloud data generation unit 17a reads the encoded point cloud data C1 with the file name “Coded_0001” corresponding to the reference data “0001” on the second row of the “reference data” item from the point cloud data storage unit 12a. Further, the point cloud data generation unit 17a reads the encoded point cloud data C₂ with the file name “Coded_File1” corresponding to the reference data “File1” on the third row of the “reference data” item from the point cloud data storage unit 12a. Here, it is assumed that the pieces of encoded point cloud data C₀ and C1 are the data shown in FIGS. 19(b) and (c), respectively, and the encoded point cloud data C₂ is the data shown in FIG. 20(b).

The point cloud data generation unit 17a initializes k to “0” (step Sc4). The point cloud data generation unit 17a selects the pieces of encoded point cloud data C_{i,k} and C_{i, k+1} (step Sc5). The point cloud data generation unit 17a determines whether a part or the whole of the range of each of the pieces of encoded point cloud data C_{i,k} and C_{i,k+1} exists within the range indicated by the range designation data based on the data indicating the range written in the “point cloud data header information” item of each of the pieces of selected encoded point cloud data C_{i, k} and C_{i, k+1} (step Sc6).

When it is determined that a part and the whole of the ranges of both pieces of encoded point cloud data C_{i, k} and C_{i, k+1} does not exist in the range indicated by the range designation data (step Sc6, No for both), the point cloud data generation unit 17a adds “2” to k to obtain a new value of k (step Sc7). Here, the case where a part or the whole of the ranges of both pieces of encoded point cloud data C_{i,k} and C_{i, k+1} does not exist in the range indicated by the range designation data corresponds to a case where the range of the encoded point cloud data C₁, k and the range indicated by the range designation data do not have an overlapping range, and the range of the encoded point cloud data C_{i, k+1} and the range indicated by the range designation data do not have an overlapping range.

The point cloud data generation unit 17a determines whether the new k satisfies k>K (step Sc8). When it is determined that k>K (step Sc8, Yes), the point cloud data generation unit 17a outputs a message indicating that there is no processing target, that is, there is no point cloud data corresponding to both the time designation data and the range designation data (step Sc9), and the processing ends.

On the other hand, when it is determined that k>K is not satisfied (step Sc8, No), the processing proceeds to step Sc5, and the point cloud data generation unit 17a selects the next two pieces of encoded point cloud data C_{i,k} and C_{i, k+1} in the time-series order. Note that when k=K, the point cloud data generation unit 17a selects only the encoded point cloud data Ci, K in the subsequent processing of step Sc5 because the encoded point cloud data Ci, K+1 does not exist. In this case, in the processing of step Sc6, the point cloud data generation unit 17a performs processing of determining whether a part or the whole of the range of the encoded point cloud data Ci , K exists in the range indicated by the range designation data.

If the point cloud data generation unit 17a determines that a part or the whole of the range of the encoded point cloud data Ci, K exists in the range indicated by the range designation data, the processing proceeds to step Sc10. On the other hand, when the point cloud data generation unit 17a determines that a part or the whole of the range of the encoded point cloud data Ci, K does not exist in the range indicated by the range designation data, the processing proceeds to step Sc7, and then, the processing ends.

In the processing of step Sc6, when it is determined that a part or the whole of the range of any one of the pieces of encoded point cloud data C_{i,k} and C_{i,k+1} exists in the range indicated by the range designation data (step Sc4, Yes for one), the point cloud data generation unit 17a sets encoded point cloud data existing in the range indicated by the range designation data as the encoded point cloud data E (step Sc10). After that, the processing proceeds to the processing of step Sc13 in FIG. 17, as indicated by connection point A in FIGS. 16 and 17.

In the processing of step Sc6, when it is determined whether a part or the whole of the ranges of both pieces of encoded point cloud data C_{i,k} and C_{i,k+1} exists in the range indicated by the range designation data (step Sc4, Yes for both), the point cloud data generation unit 17a performs tile merging processing on the encoded point cloud data C_{i,k} and C_{i,k+1}, which is the processing of the subroutine shown in FIG. 18 (step Sc11).

The tile merging processing for the encoded point cloud data C_{i,k} and C_{i,k+1} will be described with reference to the flowchart shown in FIG. 18. The point cloud data generation unit 17a detects all combinations of the tile identification information and the tile reference position data of tiles of which a part or the whole of the range exists in the range indicated by the range designation data from the “tile header information” item of each of the pieces of encoded point cloud data C_{i,k} and C_{i,k+1} based on the tile header reference position data in the “tile header information” item of the encoded point cloud data C_{i,k} and C_{i,k+1} which is the two pieces of processing target encoded point cloud data and the size of a tile indicated by the definition data (step Sd1).

The point cloud data generation unit 17a determines whether a combination of the tile identification information and the tile reference position data in which the positions indicated by the tile reference position data are the same exists in the detected combinations (step Sd2). When it is determined that there is a combination in which the positions indicated by the tile reference position data are the same (step Sd2, Yes), the point cloud data generation unit 17a merges the encoded point cloud data Ci, k and the encoded point cloud data C_{i,k+1} so as to include the tile identification information of the encoded point cloud data (that is, the encoded point cloud data C_{i, k+1}) that comes later in the time-series order among the combinations in which the positions indicated by the tile reference position data are the same, a combination with the tile reference data, and the octree-encoded data corresponding to the tile identification information to generate new encoded point cloud data (step Sd3).

On the other hand, when it is determined that there is no combination in which the positions indicated by the tile reference position data are the same (step Sd2, No), the point cloud data generation unit 17a merges the encoded point cloud data Ci, k and the encoded point cloud data C_{i,k+1} to generate new encoded point cloud data (step Sd4).

The point cloud data generation unit 17a writes the time written in the “measurement time” item of the encoded point cloud data C_{i,k+1} that comes later in the time-series order in the “measurement time” item of the newly-generated encoded point cloud data (step Sd5), and the processing of the subroutine ends. The point cloud data generation unit 17a sets the encoded point cloud data newly generated in the processing of the subroutine of step Sc11 as encoded point cloud data E (step Sc12). After that, the processing proceeds to the processing of step Sc13 in FIG. 17, as indicated by connection point A in FIGS. 16 and 17.

For example, in the case of the encoded point cloud data C₀ shown in FIG. 19(b) and the encoded point cloud data C1 shown in FIG. 19(c), it is assumed that the processing of step Sc11, that is, the tile merging processing shown in FIG. 18 is performed on the encoded point cloud data C₀ and the encoded point cloud data C1. Here, it is assumed that a part or the whole of the ranges of the tile C_{0,1} in the “tile header information” item of the encoded point cloud data C₀ and the tiles C1,1 and C1,2 in the “tile header information” item of the encoded point cloud data C₁ exists within the range indicated by the range designation data. On the other hand, it is assumed that a part or the whole of the range of the tile C1,3 in the “tile header information” item of the encoded point cloud data C1 does not exist in the range indicated by the range designation data. In this case, the point cloud data generation unit 17a detects the tiles C_{0,1}, C_{1,1}, and C_{1,2} in the processing of step Sd1, but does not detect the tile C1,3.

Since the tile reference positions of the detected tiles C_{0,1}, C_{1,1}, and C_{1,2} are different, the point cloud data generation unit 17a makes a “No” determination in the determination processing of step Sd2. In the processing of step Sd4 performed after step Sd2, after merging the tile C_{0,1} of the encoded point cloud data C₀ and the tiles C1,1 and C1,2 of the encoded point cloud data C1, the point cloud data generation unit 17a performs the processing of step Sd5 to generate the encoded point cloud data E shown in FIG. 20(a).

As shown in FIG. 20(a), in the encoded point cloud data E obtained by merging the pieces of encoded point cloud data C₀ and C₁ by the tile merging processing, the time “t₁” written in the “measurement time” item of the encoded point cloud data C₁ that comes later in the time-series order is written in the “measurement time” item. The data indicating the range of the tiles C_{0,1}, C_{1,1}, and C_{1,2} detected by the point cloud data generation unit 17a in the processing of step Sd1 is written in the “point cloud data header information” item.

The tile identification information of each of the tiles C_{0,1}, C_{1,1}, and C_{1,2} detected by the point cloud data generation unit 17a in the processing of step Sd1 and the tile reference position data are written in the “tile header information” item. The octree-encoded data corresponding to the tile identification information of each of the tiles C_{0,1}, C_{1,1}, and C_{1,2} is written in the “encoded data” item.

Next, the processing after step Sc13 will be described with reference to FIG. 17. The point cloud data generation unit 17a adds “1” to k to obtain a new value of “k” (step Sc13). The point cloud data generation unit 17a determines whether the new k satisfies k>K (step Sc14). When it is determined that k>K is not satisfied (step Sc14, No), the point cloud data generation unit 17a determines whether a part or the whole of the range of the encoded point cloud data C_{i,k} exists in the range indicated by the range designation data by referring to the data indicating the range written in the “point cloud data header information” item of the encoded point cloud data C_{i,k} selected based on the new k (step Sc15).

When the point cloud data generation unit 17a determines that a part or the whole of the range of the encoded point cloud data C_{i,k} does not exist in the range indicated by the range designation data (step Sc15, No), the processing proceeds to step Sc13. On the other hand, when it is determined that a part or the whole of the range of the encoded point cloud data C_{i,k} exists in the range indicated by the range designation data (step Sc15, Yes), the point cloud data generation unit 17a performs the tile merging processing on the encoded point cloud data C_{i,k,E} which is the processing of the subroutine shown FIG. 18 (step Sc16). The point cloud data generation unit 17a sets the encoded point cloud data newly generated in the processing of the subroutine of step Sc16 as encoded point cloud data E (step Sc17). After that, the processing proceeds to the processing of step Sc13.

For example, in the case of the encoded point cloud data E shown in FIG. 20(a) and the encoded point cloud data C₂ shown in FIG. 20(b), it is assumed that the processing of step Sc16, that is, the tile merging processing shown in FIG. 18 is performed on the encoded point cloud data E and the encoded point cloud data C₂. Here, it is assumed that a part or the whole of the ranges of the tiles C_{2,1} and C_{2,2} in the “tile header information” item of the encoded point cloud data C₂ exists in the range indicated by the range designation data. In this case, in the processing of step Sd1, the point cloud data generation unit 17a detects the tiles C₀,1, C_{1,1}, and C_{1,2} of the encoded point cloud data E and the tiles C_{2,1} and C_{2,2} of the encoded point cloud data C₂.

Since both the position indicated by the reference position data of the detected tile C_{1,1} and the position indicated by the tile reference position data of the detected tile C_{2,1} are both (x_{T-02}, y_{T-02}, z_{T-02}), the point cloud data generation unit 17a makes a “Yes” determination in the processing of step Sd2. In the subsequent processing of step Sd3, after merging the encoded point cloud data E and the encoded point cloud data C₂ so as to include the tile C_{2,1} that comes later in the time-series order, the point cloud data generation unit 17a performs the processing of step Sd5 to generate the encoded point cloud data E shown in FIG. 20(c).

As shown in FIG. 20(c), in the encoded point cloud data E obtained merging the encoded point cloud data E shown in FIG. 20(a) and the encoded point cloud data C1 shown in FIG. 20(b) in the tile merging processing, the time “t₂” written in the “measurement time” item of the encoded point cloud data C₂ that comes later in the time-series order is written in the “measurement time” item. The data indicating the ranges of the remaining tiles C_{0,1}, C_{1,2}, C_{2,1}, and C_{2,2} excluding the tile C_{1,1} that was not merged in the processing of step Sd3 from the tiles C_{0,1}, C_{1,1}, C_{1,2}, C_{2,1}, and C_{2,2} detected by the point cloud data generation unit 17a in the processing of step Sd1 is written in the “point cloud data header information” item. The tile identification information and the tile reference position data of each of the tiles C_{0,1}, C_{1,2}, C_{2,1}, and C_{2,2} are written in the “tile header information” item. The octree-encoded data corresponding to the tile identification information of each of the tiles C_{0,1}, C_{1,2}, C_{2,1}, and C_{2,2} is written in the “encoded data” item.

In the processing of step Sc14, when the point cloud data generation unit 17a determines that k>K is satisfied (step Sc14, Yes), the point cloud data generation unit 17a outputs the encoded point cloud data E generated last to the decoding processing unit 19. The decoding processing unit 19 acquires the encoded point cloud data E output by the point cloud data generation unit 17a, and performs decoding processing on the acquired encoded point cloud data E according to the definition data. By performing the decoding processing, the coordinate values of the X-axis, Y-axis, and Z-axis of each point indicated by the octree-encoded data included in the encoded point cloud data E are restored. The decoding processing unit 19 generates point cloud data including the restored coordinate values of the X-axis, Y-axis, and Z-axis of each point and the time written in the “measurement time” item of the encoded point cloud data and outputs the generated point cloud data to the outside (step Sc18). The point cloud data output to the outside is the point cloud data corresponding to the time designation data and the range designation data.

In the point cloud data processing device 1a of the second embodiment, the point cloud data storage unit 12a stores the encoded point cloud data in which the points are encoded by the octree encoding for respective tiles partially or wholly included in the range of the point cloud data, and the encoded point cloud data is tile reference position data indicating the position of a tile including the points included in the point cloud data and has tile header information including the tile reference position data which is location data.

As a result, the point cloud data processing device 1a of the second embodiment has the following effects in addition to the effects of the point cloud data processing device 1 of the first embodiment. That is, in the point cloud data processing device 1a, the encoded point cloud data obtained by octree-encoding the point cloud data is subjected to merging processing. Since the encoded point cloud data is octree-encoded, it is possible to specify the range in which points exist in units of tiles. Therefore, the point cloud data processing device 1a narrows down the encoded point cloud data to be merged using the reference list data corresponding to the time indicated by the time designation data, and further narrows down the encoded point cloud data in which points exist within the range indicated by the range designation data based on the point cloud data header information indicating the range of tiles in which points in the encoded point cloud data exist. After that, the point cloud data processing device 1a narrows down tiles in which points exist within the range indicated by the range designation data, among the tiles of the narrowed-down encoded point cloud data.

If there are tiles at the same position among the narrowed-down tiles, the point cloud data processing device 1a merges the tiles that come later in the time-series order in units of tiles to generate merged encoded point cloud data. Therefore, the point cloud data processing device 1a of the second embodiment can reduce the amount of data to be merged compared to the point cloud data processing device 1 of the first embodiment. In other words, the point cloud data processing device 1a of the second embodiment, unlike the point cloud data processing device 1 of the first embodiment, performs merging in units of tiles based on the tile reference position data indicating the position of a tile indicated by the tile header information rather than performing merging based on the coordinate data of a plurality of points included in the point cloud data. Since each tile often includes a plurality of points, merging in units of tiles also means merging a plurality of points collectively. Then, since the point cloud data processing device 1a of the second embodiment merges a plurality of points collectively, merging can be performed in less time than the point cloud data processing device 1 of the first embodiment which performs merging point by point. Shortening the time required for merging means that the time required for generating reference list data and the time required for generating point cloud data based on the reference list data can be reduced. Therefore, the point cloud data processing device 1a of the second embodiment can shorten the time required for integrating a plurality of pieces of point cloud data acquired at an arbitrary time and at an arbitrary measurement position compared to the point cloud data processing device 1 of the first embodiment.

In the above-described second embodiment, the encoding processing unit 18 repeats dividing the block into eight until one point is included in the block and the position of the one point becomes the position of a representative point of the block. On the other hand, the encoding processing unit 18 may divide a block into eight until the number of points included in the block reaches a predetermined number, and associate coordinate data indicating the relative coordinate of each point included in the block on the bottom layer in which the number of points has reached the predetermined number with the octree-encoded data indicating the block on the bottom layer to generate encoded point cloud data. The octree encoding described in the above-described second embodiment is octree encoding of lossless encoding that perfectly reproduces the positions of points by decoding. On the other hand, the encoding processing unit 18 may perform octree encoding of lossy encoding. When performing octree encoding of lossy encoding, the encoding processing unit 18 performs quantization by further dividing the block on the bottom layer in which the number of points has reached the predetermined number into a plurality of cubes of the same size and approximates the position of each point included in the block on the bottom layer by a representative point of the quantized cube, for example, the position of the center of the cube. The encoding processing unit 18 generates encoded point cloud data by associating the information indicating the approximated position with the octree-encoded data indicating the block on the bottom layer.

In the second embodiment described above, the merged point cloud data generation unit 13a generates the merged point cloud data in the data format shown in FIG. 15(b). On the other hand, the merged point cloud data generation unit 13a may generate the merged point cloud data in the data format generated by the merged point cloud data generation unit 13 of the first embodiment, that is, the merged point cloud data in the data format shown in FIG. 3. When generating the merged point cloud data in the data format shown in FIG. 3, the tile reference position data in the “tile header information” item of the merged point cloud data of the data format shown in FIG. 15(b) is written in the “coordinate data” item of the merged point cloud data. In this case, the point cloud data processing device 1a can generate reference list data by including the reference list generation unit 15 of the first embodiment instead of the reference list generation unit 15a of the second embodiment.

In the above-described second embodiment, the definition data is provided to the point cloud data generation unit 17a, the encoding processing unit 18, and the decoding processing unit 19. In contrast, definition data may be determined in advance, and the predetermined definition data may be stored in a storage area inside each of the point cloud data generation unit 17a, the encoding processing unit 18, and the decoding processing unit 19 so that the point cloud data generation unit 17a, the encoding processing unit 18, and the decoding processing unit 19 refer to the definition data stored in the respective internal storage areas.

In the above-described second embodiment, the encoding processing unit 18 generates encoded point cloud data in the data format shown in FIG. 13, for example. However, the data format shown in FIG. 13 is an example, and the encoding processing unit 18 may generate encoded point cloud data in the G-pcc data format, for example.

### (Processing When Measurement Time Data is Not Included in Point Cloud Data (Part 1))

In the first and second embodiments described above, the data format of each piece of point cloud data acquired by the point cloud data acquisition unit 11 is a data format including the measurement time data, as shown in FIG. 2. On the other hand, the data format of the point cloud data may be a data format that does not include the measurement time data. In this case, for example, the user of the point cloud data processing device 1 may have another file in which the file name of the point cloud data and the time indicated by the measurement time data are associated with each other. When performing an operation to designating the file of point cloud data to be acquired by the point cloud data acquisition unit 11 while referring to the file, the user may perform an operation of designating data indicating the measurement time corresponding to the point cloud data and providing it to the point cloud data acquisition unit 11. In this way, the point cloud data acquisition unit 11 can associate the point cloud data with the data indicating the measurement time of the point cloud data. This association may be an association in which the measurement time data corresponding to the point cloud data is written at the beginning of the point cloud data as shown in FIG. 2, and may be an association in which one file is generated by combining the point cloud data and the measurement time data corresponding to the point cloud data.

### (Process When Measurement Time Data is Not Included in Point Cloud Data (Part 2))

If the point cloud data does not include the measurement time data, the following processing may be performed in the first and second embodiments. First, processing in the case of the first embodiment will be described. The point cloud data storage unit 12 stores point cloud data that does not include measurement time data. The user provides the merged point cloud data generation unit 13 with the generation instruction data including information indicating merge all, and further including data indicating the time-series order of the pieces of point cloud data. When the generation instruction data is acquired and it is determined in the processing of step Sa2 that the information included in the acquired generation instruction data is information indicating merge all, the merged point cloud data generation unit 13 reads the data indicating the time-series order of the pieces of point cloud data, included in the generation instruction data.

The merged point cloud data generation unit 13 reads the point cloud data from the point cloud data storage unit 12 in the order indicated by the read data indicating the time-series order of the pieces of point cloud data, and arranges the pieces of read point cloud data in the time-series order. After that, the processing after step Sa4 is performed. In the processing of steps Sa5 and Sa8, the reference list generation unit 15 outputs a message prompting the user to add data indicating the time to the reference list data Rᵢ whenever generating the reference list data Rᵢ (here, i is an integer from 1 to N). When the user refers to the message, the user performs an operation of writing the time corresponding to the reference list data Rᵢ in the “merge reference time” item of the reference list data Rᵢ written in the reference list storage unit 16.

In this case, no data is written in the “merge reference time” item of the merged point cloud data B₁ to B_{N}. Therefore, when it is determined in the processing of step Sa2 that the information included in the generation instruction data is information indicating individual merges, the merged point cloud data generation unit 13 does not perform the processing of steps Sa9 and Sa10. Instead of performing the processing of steps Sa9 and Sa10, the merged point cloud data generation unit 13 performs the processing of steps Sa11 to Sa13 regarding that the measurement time of the point cloud data A_{M} corresponding to the file name associated with the information indicating individual merges is the time before the measurement time of each of the pieces of point cloud data A₁ to A_{N} merged with the merged point cloud data B_{N} stored in the merged point cloud data storage unit 14. In this case as well, when the reference list data R_{M} is generated in step Sa13, the reference list generation unit 15 outputs a message prompting the user to add data indicating time to the reference list data R_{M}. When the user refers to the message, the user performs an operation of writing the time corresponding to the reference list data R_{M} in the “merge reference time” item of the reference list data R_{M} written in the reference list storage unit 16.

Next, processing in the case of the second embodiment will be described. Since the point cloud data output by the point cloud data acquisition unit 11 does not include measurement time data, the encoding processing unit 18 generates encoded point cloud data in which no data is written in the “measurement time” item and writes the encoded point cloud data in the point cloud data storage unit 12a. As in the first embodiment, the user provides the merged point cloud data generation unit 13 with the generation instruction data including information indicating merge all, and further including data indicating the time-series order of the pieces of encoded point cloud data. When the generation instruction data is acquired and it is determined in the processing of step Sa2 that the information included in the acquired generation instruction data is information indicating merge all, the merged point cloud data generation unit 13a reads the data indicating the time-series order of the pieces of encoded point cloud data, included in the generation instruction data.

The merged point cloud data generation unit 13a reads the encoded point cloud data from the point cloud data storage unit 12 in the order indicated by the read data indicating the time-series order of the pieces of encoded point cloud data, and arranges the pieces of read encoded point cloud data in the time-series order. After that, the processing after step Sa4 in the second embodiment is performed. In subsequent processing, similarly to the processing of the first embodiment described above, the reference list generation unit 15a outputs a message prompting the user to add data indicating the time to the reference list data Rᵢ whenever generating the reference list data Rᵢ. When the user refers to the message, the user performs an operation of writing the time corresponding to the reference list data Rᵢ in the “merge reference time” item of the reference list data Rᵢ written in the reference list storage unit 16.

In the second embodiment, when the generation instruction data includes information indicating individual merges, the merged point cloud data generation unit 13a does not perform the processing of steps Sa9 and Sa10, as in the first embodiment but performs the processing of steps Sa11 to Sa13 in the second embodiment regarding that the measurement time of the encoded point cloud data C_{M} corresponding to the file name associated with the information indicating individual merges is the time before the measurement time of each of the pieces of encoded point cloud data C₁ to C_{N} merged with the merged point cloud data D_{N} stored in the merged point cloud data storage unit 14a. Note that, in the first and second embodiments, when outputting a message prompting the user to add data indicating time to the reference list data R₁, the reference list generation units 15 and 15a may output the message including the reference data on the last row of the “reference data” item of the reference list data R₁. By doing so, the user can easily specify the file name of the point cloud data or the encoded point cloud data corresponding to the time written in the “merge reference time” item of the reference list data R₁ based on the reference data included in the message.

### (Other Configuration Examples of First and Second Embodiments)

In the first and second embodiments described above, the time indicated by the measurement time data included in the point cloud data is, for example, the time when the point cloud data was generated by the measuring device. On the other hand, the time indicated by the measurement time data included in the point cloud data may be the time as follows. For example, depending on the point cloud data, each coordinate data of points may be associated with the measurement time at which the point was measured. In such a case, the merged point cloud data generation unit 13 may use the earliest or latest measurement time of the points included in the point cloud data file or the average time of the earliest and latest measurement times as the measurement time of the point cloud data file.

In the first and second embodiments described above, the file format of the point cloud data acquired by the point cloud data acquisition unit 11 is determined in advance, and the merged point cloud data generation unit 13, the point cloud data generation unit 17, and the encoding processing unit 18 refer to data included in the point cloud data according to the predetermined file format. In contrast, when the point cloud data acquisition unit 11 acquires point cloud data in a plurality of file formats, the merged point cloud data generation unit 13, the point cloud data generation unit 17, and the encoding processing unit 18 may, for example, perform different reading processes according to the extension given to the file name such as “.ply” or “.csv” to acquire data included in the point cloud data.

In the first and second embodiments described above, transcoders, for example, are used as the merged point cloud data generation units 13 and 13a, the reference list generation units 15 and 15a, and the point cloud data generation units 17 and 17a. When transcoders are used, the merged point cloud data generation unit 13 and the reference list generation unit 15 may be realized by one transcoder in the first embodiment, and the merged point cloud data generation unit 13a and the reference list generation unit 15a may be realized by one transcoder in the second embodiment.

In the above-described first and second embodiments, the point cloud data includes the coordinate data indicating the positions of points. However, the point cloud data may further include data indicating the colors of points, for example, data indicating intensity values of the red, blue, and green light, and data indicating reflection intensities. Note that the merged point cloud data generation unit 13, the point cloud data generation unit 17, the encoding processing unit 18, and the decoding processing unit 19 perform processing regarding points having different colors or reflection intensities as different points even if the positions indicated by the coordinate data of the points are the same.

As described above, both the first embodiment and the second embodiment are common in that the objects to be merged are data indicating the locations of points in the point cloud data. That is, in the first embodiment, coordinate data indicating the position of a point is used as the location data indicating the location of the point, and reference data is associated with the coordinate data as attribute information. In the second embodiment, tile reference position data indicating the position of a tile including a point is used as location data indicating the location of the point, and reference data is associated with the tile reference position data as attribute information. In addition to these, data indicating the position of a structure such as a mesh or a polygon including points may be used as the location data indicating the location of a point, and reference data may be associated with the data as attribute information.

In the above-described first embodiment, when merging two pieces of point cloud data, if a point of the point cloud data that is earlier in the time-series order exists in a range of a predetermined size around a point of the point cloud data that is later in the time-series order, the merged point cloud data generation unit 13 and the point cloud data generation unit 17 perform processing of selecting the point of the point cloud data that is later in the time-series order as a merging target. When the merged point cloud data generation unit 13 performs the selection processing, it is possible to reduce the number of pieces of reference data included in the reference list data generated by the reference list generation unit 15. Thus, there is an advantage that the number of pieces of point cloud data when the point cloud data generation unit 17 merges point cloud data. However, even if both the merged point cloud data generation unit 13 and the point cloud data generation unit 17 do not perform the same processing as described above, the point cloud data desired by the user can be obtained when the point cloud data generation unit 17 performs the processing. Therefore, the merged point cloud data generation unit 13 may not perform the selection processing. Also in the second embodiment, when merging two pieces of encoded point cloud data, if tiles in which the tile reference positions are the same exist in the two pieces of encoded point cloud data, the merged point cloud data generation unit 13a performs the processing of selecting the tile that is later in the time-series order as the merging target. However, the merged point cloud data generation unit 13a may not perform the selection processing due to the above-described reasons.

In the above-described first and second embodiments, “time” indicates the time represented by year, month, day, hour, minute, and second, but may indicate the time represented by year, month, and day without the units of hour, minute, and second. In this case, for example, data indicating time such as measurement time data is data including values in units of year, month, and day.

The point cloud data processing devices 1 and 1a in the above-described embodiments may be realized by computers. In this case, it may be realized by recording the program for realizing these functions on a computer-readable recording medium, reading the program recorded in the recording medium into the computer system, and executing the program. Note that the “computer system” mentioned here includes OS and hardware such as peripheral equipment. In addition, the “computer-readable recording medium” includes a portable medium such as a flexible disc, a magneto-optical disc, a ROM, and a CD-ROM, and a storage device such as a hard disk built in the computer system. Furthermore, the “computer-readable recording medium” may also include a recording medium that dynamically holds a program for a short time period such as a communication wire when the program is to be transmitted via a network such as the Internet or a communication line such as a telephone line as well as a recording medium that holds a program for a certain time period such as a volatile memory inside a computer system serving as a server or a client in that case. Moreover, the program described above may be any of a program for realizing some of the functions described above, a program capable of realizing the functions described above in combination with a program already recorded in the computer system, and a program for realizing the functions by using a programmable logic device such as a Field Programmable Gate Array (FPGA).

Although the embodiment of the present invention has been described in detail with reference to the drawings, a specific configuration is not limited to this embodiment, and design within the scope of the gist of the present invention, and the like are included.

### INDUSTRIAL APPLICABILITY

The present invention can be applied to techniques for processing a plurality of pieces of point cloud data.

### REFERENCE SIGNS LIST

1 Point cloud data processing device,

11 Point cloud data acquisition unit,

12 Point cloud data storage unit,

13 Merged point cloud data generation unit,

14 Merged point cloud data storage unit,

15 Reference list generation unit,

16 Reference list storage unit,

17 Point cloud data generation unit

1. A point cloud data processing device comprising:
a point cloud data storage unit that stores a plurality of pieces of point cloud data measured at an arbitrary measurement time at a plurality of measurement positions in a three-dimensional space; and
a merged point cloud data generation unit that generates merged point cloud data in a time-series order based on the point cloud data stored in the point cloud data storage unit, the merged point cloud data including the point cloud data corresponding to any one of the measurement times, location data indicating a location of a point when pieces of point cloud data measured before the measurement time were integrated in a time-series order, and reference data assigned to each piece of location data, for specifying the point cloud data including the point indicated by the location data.

2. The point cloud data processing device according to claim 1, further comprising:
a reference list generation unit that selects different pieces of reference data from the reference data included in the merged point cloud data generated by the merged point cloud data generation unit in a time-series order and generates reference list data including the reference data selected in the time-series order for each of the measurement times of the plurality of pieces of point cloud data.

3. The point cloud data processing device according to claim 2, wherein
the three-dimensional space is divided into cubes of a same predetermined size, each of the divided cubes being determined in advance as a tile, and
the point cloud data stored in the point cloud data storage unit is encoded point cloud data in which each point is encoded by octree encoding for each of the tiles partly or wholly included in a range of the point cloud data, and the encoded point cloud data has tile header information including tile reference position data, which is the location data, indicating a position of the tile including the points included in the point cloud data.

4. The point cloud data processing device according to claim 3, further comprising:
a point cloud data generation unit that receives time designation data designating a time and range designation data indicating a range, selects the reference list data of the measurement time corresponding to the time indicated by the received time designation data, reads the encoded point cloud data corresponding to the reference data included in the selected reference list data from the point cloud data storage unit, and integrates the read encoded point cloud data in a time-series order in units of tiles based on the tile header information included in the read encoded point cloud data and the range designation data to generate encoded point cloud data corresponding to the time indicated by the time designation data and the range indicated by the range designation data; and
a decoding processing unit that decodes the encoded point cloud data generated by the point cloud data generation unit to generate point cloud data.

5. The point cloud data processing device according to claim 4, wherein
the encoded point cloud data stored in the point cloud data storage unit further includes point cloud data header information indicating a range of the encoded point cloud data, and
the point cloud data generation unit selects the encoded point cloud data including a point in the range indicated by the range designation data among the pieces of encoded point cloud data read from the point cloud data storage unit based on the point cloud data header information and the range designation data and integrates the selected encoded point cloud data in a time-series order in units of tiles based on the tile header information and the range designation data to generate encoded point cloud data corresponding to the time indicated by the time designation data and the range indicated by the range designation data.

6. The point cloud data processing device according to claim 4, wherein
when integrating the encoded point cloud data in the time-series order in units of tiles, if there are tiles in which the positions indicated by the tile reference position data are the same, the point cloud data generation unit sets tiles included in the encoded point cloud data that is later in the time-series order as a merging target and integrates the encoded point cloud data in the time-series order in units of tiles.

7. A point cloud data processing method comprising:
allowing a point cloud data storage unit to store a plurality of pieces of point cloud data measured at an arbitrary measurement time at a plurality of measurement positions in a three-dimensional space; and
allowing a merged point cloud data generation unit to generate merged point cloud data in a time-series order based on the point cloud data stored in the point cloud data storage unit, the merged point cloud data including the point cloud data corresponding to any one of the measurement times, location data indicating a location of a point when pieces of point cloud data measured before the measurement time were integrated in a time-series order, and reference data assigned to each piece of location data, for specifying the point cloud data including the point indicated by the location data.

8. A non-transitory computer-readable medium having computer-executable instructions that, upon execution of the instructions by a processor of a computer, cause the computer to function as:
a point cloud data storage means that stores a plurality of pieces of point cloud data measured at an arbitrary measurement time at a plurality of measurement positions in a three-dimensional space; and
a merged point cloud data generation means that generates merged point cloud data in a time-series order based on the point cloud data stored in the point cloud data storage means, the merged point cloud data including the point cloud data corresponding to any one of the measurement times, location data indicating a location of a point when pieces of point cloud data measured before the measurement time were integrated in a time-series order, and reference data assigned to each piece of location data, for specifying the point cloud data including the point indicated by the location data.
